(19) United States
(12) Patent Application Publication
(10) Pub. No.: US 2013/0178236 A1
(43) Pub. Date: Jul. 11, 2013

(54) NETWORK DEVICES, COMMUNICATION END DEVICES, METHODS FOR CONTROLLING A NETWORK DEVICE AND METHODS FOR CONTROLLING A COMMUNICATION END DEVICE

(71) Applicant: Frank Kowalewski, Goettingen (DE)

(72) Inventor: Frank Kowalewski, Goettingen (DE)

(73) Assignee: INTEL MOBILE COMMUNICATIONS GMBH, Neubiberg (DE)

(21) Appl. No.: 13/347,734

(22) Filed: Jan. 11, 2012

(51) Int. Cl. H04M 11/00; H04W 4/12

(52) U.S. Cl. 455/466; 379/93.01

(57) ABSTRACT

In an aspect of this disclosure, a network device of a network may be provided. The network device may include: an interface configured to receive text from a communication end device via a communication protocol; a memory configured to store recipient identifiers in relation to textual names; and a recipient identifier acquirer configured to acquire from the memory a recipient identifier based on the received text. The communication protocol may be configured to exchange information only between communication end devices of the network and network devices of the network.

### TECHNICAL FIELD

Aspects of this disclose relate generally to network devices, communication end devices, methods for controlling a network device and methods for controlling a communication end device.

### BACKGROUND

For initiating a call, a user of a communication end device commonly inputs a telephone number of a desired recipient into the communication end device, and the communication end device establishes a connection with another communication end device corresponding to the input telephone number.

### SUMMARY

In an aspect of this disclosure, a network device of a network may be provided. The network device may include: an interface configured to receive text from a communication end device via a communication protocol; a memory configured to store recipient identifiers in relation to textual names; and a recipient identifier acquirer configured to acquire from the memory a recipient identifier based on the received text. The communication protocol may be configured to exchange information only between communication end devices of the network and network devices of the network.

In an aspect of this disclosure, a communication end device may be provided. The communication end device may include: a text sender configured to send text via a communication protocol to a network device of a network; and a recipient identifier receiver configured to receive a recipient identifier from the network device in response to the sent text. The communication protocol may be configured to exchange information only between communication end devices of the network and network devices of the network.

In an aspect of this disclosure, a method for controlling a network device of a network may be provided. The method may include: receiving text from a communication end device via a communication protocol; storing in a memory recipient identifiers in relation to textual names; and acquiring from the memory a recipient identifier based on the received text. The communication protocol may be configured to exchange information only between communication end devices of the network and network devices of the network.

In an aspect of this disclosure, a method for controlling a communication end device may be provided. The method may include: sending text via a communication protocol to a network device of a network; and receiving a recipient identifier from the network device in response to the sent text. The communication protocol may be configured to exchange information only between communication end devices of the network and network devices of the network.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various aspects of this disclosure. In the following description, various aspects of this disclosure are described with reference to the following drawings, in which:

FIG. 1 shows a network device in accordance with an aspect of this disclosure;

FIG. 2 shows a network device in accordance with an aspect of this disclosure;

FIG. 3 shows a communication end device in accordance with an aspect of this disclosure;

FIG. 4 shows a communication end device in accordance with an aspect of this disclosure;

FIG. 5 shows a flow diagram illustrating a method for controlling a network device in accordance with an aspect of this disclosure;

FIG. 6 shows a flow diagram illustrating a method for controlling a communication end device in accordance with an aspect of this disclosure;

FIG. 7 shows a network device in accordance with an aspect of this disclosure;

FIG. 8 shows a communication end device in accordance with an aspect of this disclosure;

FIG. 9 shows a flow diagram illustrating a method for controlling a network device in accordance with an aspect of this disclosure;

FIG. 10 shows a flow diagram illustrating a method for controlling a communication end device in accordance with an aspect of this disclosure;

FIG. 11 shows a network device in accordance with an aspect of this disclosure;

FIG. 12 shows a communication end device in accordance with an aspect of this disclosure;

FIG. 13 shows a flow diagram illustrating a method for controlling a network device in accordance with an aspect of this disclosure;

FIG. 14 shows a flow diagram illustrating a method for controlling a communication end device in accordance with an aspect of this disclosure;

FIG. 15 shows a network device in accordance with an aspect of this disclosure;

FIG. 16 shows a communication end device in accordance with an aspect of this disclosure;

FIG. 17 shows a flow diagram illustrating a method for controlling a network device in accordance with an aspect of this disclosure;

FIG. 18 shows a flow diagram illustrating a method for controlling a communication end device in accordance with an aspect of this disclosure;

FIG. 19 shows a network device in accordance with an aspect of this disclosure;

FIG. 20 shows a communication end device in accordance with an aspect of this disclosure;

FIG. 21 shows a flow diagram illustrating a method for controlling a network device in accordance with an aspect of this disclosure;

FIG. 22 shows a flow diagram illustrating a method for controlling a communication end device in accordance with an aspect of this disclosure;

FIG. 23 shows a network device in accordance with an aspect of this disclosure;

FIG. 24 shows a communication end device in accordance with an aspect of this disclosure;

FIG. 25 shows a flow diagram illustrating a method for controlling a network device in accordance with an aspect of this disclosure;

FIG. 26 shows a flow diagram illustrating a method for controlling a communication end device in accordance with an aspect of this disclosure;

FIG. 27 shows a network architecture in accordance with an aspect of this disclosure;

FIG. 28 shows a flow diagram illustrating a signaling flow in accordance with an aspect of this disclosure;

FIG. 29 shows a flow diagram illustrating a signaling flow in accordance with an aspect of this disclosure;

FIG. 30 shows a flow diagram illustrating a signaling flow in accordance with an aspect of this disclosure;

FIG. 31 shows a network architecture in accordance with an aspect of this disclosure; and

FIG. 32 shows a flow diagram illustrating a signaling flow in accordance with an aspect of this disclosure.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments may be combined with one or more other embodiments to form new embodiments.

The terms “coupling” or “connection” are intended to include a direct “coupling” or direct “connection” as well as an indirect “coupling” or indirect “connection”, respectively.

The word “exemplary” is used herein to mean “serving as an example, instance, or illustration”. Any aspect of this disclosure or design described herein as “exemplary” is not necessarily to be construed as preferred or advantageous over other aspects of this disclosure or designs.

The term “protocol” is intended to include any piece of software, that is provided to implement part of any layer of the communication definition.

A communication end device (which may also be referred to as end device) according to various aspects of this disclosure may be a device configured for wired communication, for example a desktop computer or laptop, or for wireless communication, for example a radio communication device. In various aspects of this disclosure, a radio communication device may be an end-user mobile device (MD). In various aspects of this disclosure, a radio communication device may be any kind of mobile radio communication device, mobile telephone, personal digital assistant, mobile computer, or any other mobile device configured for communication with a mobile communication base station (BS) or an access point (AP) and may be also referred to as a User Equipment (UE), a mobile station (MS) or an advanced mobile station (advanced MS, AMS), for example in accordance with IEEE 802.16m. In various aspects of this disclosure, a recipient may also be referred to as a callee. In various aspects of this disclosure, a recipient identifier may be at least one of a dialing number and a symbolic address.

The communication end device may include a memory which may for example be used in the processing carried out by the communication end device. The network device may include a memory which may for example be used in the processing carried out by the network device. A memory used in various aspects of this disclosure may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, for example, a floating gate memory, a charge trapping memory, an MRAM (Magnetoresistive Random Access Memory) or a PCRAM (Phase Change Random Access Memory).

In various aspects of this disclosure, a “circuit” may be understood as any kind of a logic implementing entity, which may be special purpose circuitry or a processor executing software stored in a memory, firmware, or any combination thereof. Thus, in various aspects of this disclosure, a “circuit” may be a hard-wired logic circuit or a programmable logic circuit such as a programmable processor, for example a microprocessor (for example a Complex Instruction Set Computer (CISC) processor or a Reduced Instruction Set Computer (RISC) processor). A “circuit” may also be a processor executing software, for example any kind of computer program, for example a computer program using a virtual machine code such as for example Java. Any other kind of implementation of the respective functions which will be described in more detail below may also be understood as a “circuit” in accordance with an alternative aspect of this disclosure.

Various aspects of this disclosure are provided for devices, and various aspects of this disclosure are provided for methods. It will be understood that basic properties of the devices also hold for the methods and vice versa. Therefore, for sake of brevity, duplicate description of such properties may be omitted.

It will be understood that any property described herein for a specific communication end device may also hold for any communication end device described herein. It will be understood that any property described herein for a specific network device may also hold for any network device described herein. It will be understood that any property described herein for a specific method may also hold for any method described herein. It will be understood that a network device may be a single device or may be a plurality of devices that jointly work together as one network device.

In commonly used methods, in Public Land Mobile Networks (PLMN) dialing is done using dialing numbers. PLMN end devices may store symbolic strings associated with dialing numbers. The symbolic strings may be used to look up corresponding dialing numbers. The symbolic strings may be device specific and defined by the device's user. They may not be public addresses that may be used without knowing the corresponding dialing numbers. As a consequence, in commonly used methods, PLMN end devices may not dial symbolic addresses, PLMN end device addresses may not be symbolic, PSTN (Public Switched Telephone Network) end device addresses may not be symbolic, usage of symbolic strings for looking up corresponding dialing numbers may need knowledge of the dialing numbers at the device, PLMN dialing may not be used for reaching internet based communication services, PLMN dialing may not be used with IMS (IP Multimedia Subsystem) services, PLMN dialing may not be used with INIPUI (IMS Network-Independent Public User Identities), and PLMN interworking with IMS/internet services may need interworking gateways in the IMS/internet service network.

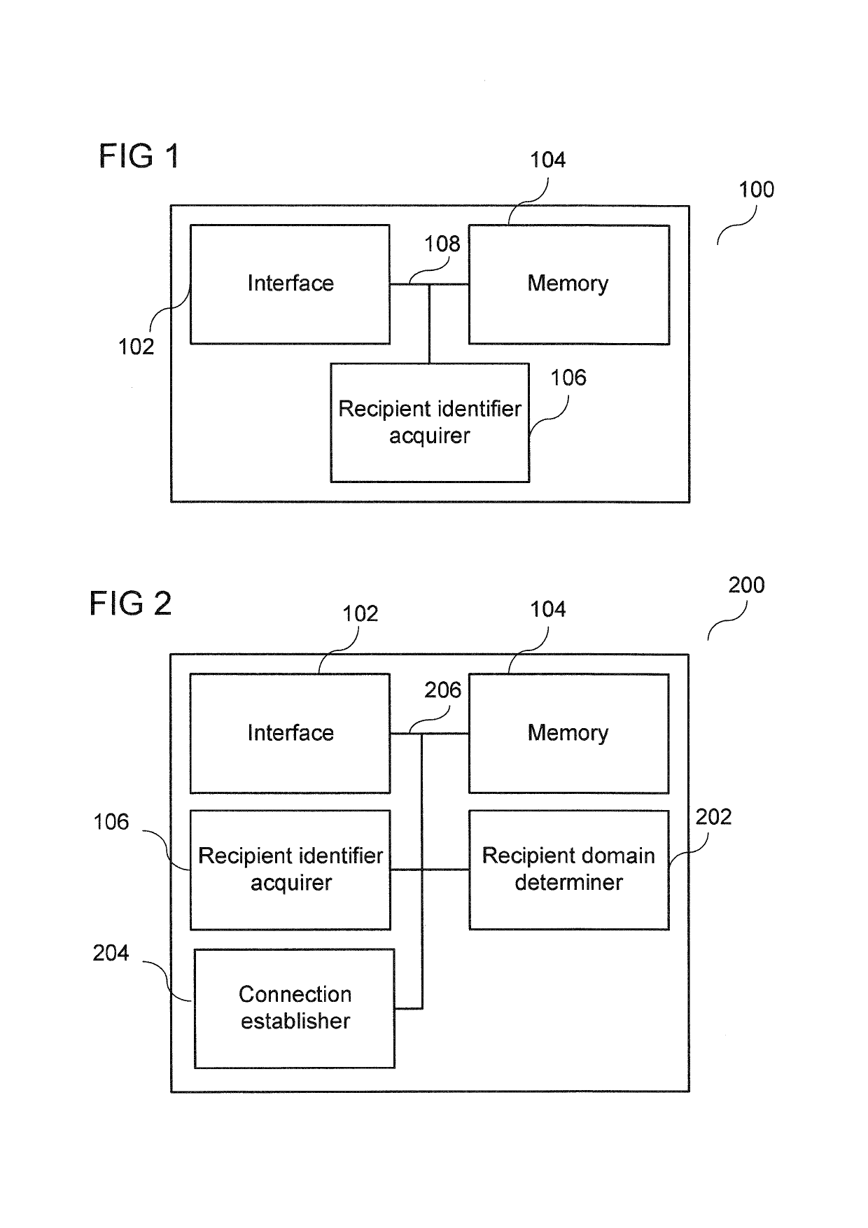

FIG. 1 shows a network device 100 in accordance with an aspect of this disclosure. The network device 100 may be a network device of a network (not shown). The network device 100 may include an interface 102 (or an interface circuit 102) configured to receive text from a communication end device (not shown) via a communication protocol. The network device 100 may further include a memory 104 configured to store recipient identifiers in relation to textual names. The network device 100 may further include a recipient identifier acquirer 106 (or recipient identifier acquisition circuit 106) configured to acquire from the memory a recipient identifier based on the received text. The communication protocol may be configured to exchange information only between communication end devices of the network and network devices of the network (in other words: the communication protocol may be configured to exchange information only between a first device and a second device, wherein the first device may be any communication end device of the network and the second device may be any network device of the network; in other words: the communication protocol may be configured to provide communication end device—network device communication; in other words: the communication protocol may be not configured to provide information between two communication end devices). The interface 102, the memory 104, and the recipient identifier acquirer 106 may be coupled with each other, e.g. via a connection 108, for example an optical connection or an electrical connection, such as e.g. a cable or a computer bus or via any other suitable electrical connection to exchange electrical signals.

In an aspect of this disclosure, the communication protocol may further be configured to exchange information between a plurality of network devices of the network.

FIG. 2 shows a network device 200 in accordance with an aspect of this disclosure. The network device 200 may, similar to the network device 100 of FIG. 1, be a network device of a network (not shown). The network device 200 may, similar to the network device 100 of FIG. 1, include an interface 102 configured to receive text from a communication end device (not shown) via a communication protocol. The network device 200 may, similar to the network device 100 of FIG. 1, further include a memory 104 configured to store recipient identifiers in relation to textual names. The network device 200 may, similar to the network device 100 of FIG. 1, further include a recipient identifier acquirer 106 configured to acquire from the memory a recipient identifier based on the received text. The network device 200 may further include a recipient domain determiner 202 (or a recipient domain determination circuit 202), like will be described in more detail below. The network device 200 may further include a connection establisher 204 (or a connection establishing circuit 204), like will be described in more detail below. The communication protocol may be configured to exchange information only between communication end devices of the network and network devices of the network. The interface 102, the memory 104, the recipient identifier acquirer 106, the recipient domain determiner 202, and the connection establisher 204 may be coupled with each other, e.g. via a connection 206, for example an optical connection or an electrical connection, such as e.g. a cable or a computer bus or via any other suitable electrical connection to exchange electrical signals.

In an aspect of this disclosure, the communication protocol may further be configured to exchange information between a plurality of network devices of the network.

In an aspect of this disclosure, the recipient domain determiner 202 may be configured to determine a domain to which the recipient belongs.

In an aspect of this disclosure, the recipient domain determiner 202 may be further configured to determine whether the recipient belongs to a telephone domain or to an internet domain.

In an aspect of this disclosure, the telephone domain may be one of a domain of a public land mobile network and a domain of a public switched telephone network.

In an aspect of this disclosure, the internet domain may be a domain of a session initiation protocol communication.

In an aspect of this disclosure, the connection establisher 204 may be configured to establish a connection with the recipient.

In an aspect of this disclosure, the connection establisher 204 may be further configured to establish the connection based on the determined domain.

In an aspect of this disclosure, the communication protocol may be a protocol for unstructured supplementary service data (USSD).

In an aspect of this disclosure, the communication protocol may be further configured to exchange at least one of symbolic data and control data.

In an aspect of this disclosure, the communication protocol may be a transport layer protocol.

In an aspect of this disclosure, the communication protocol may be an application layer protocol.

In an aspect of this disclosure, the network device 200 may only be accessible by an operator of the network. It is intended that the term “accessible” means physically accessible, for example for having physical access to the physical entity of the network device 200. It will be understood that a network connection is not to be included in the property of “being accessible”. For example, the operator of the network may be the only one who has the keys to the room in which the network device 200 is provided.

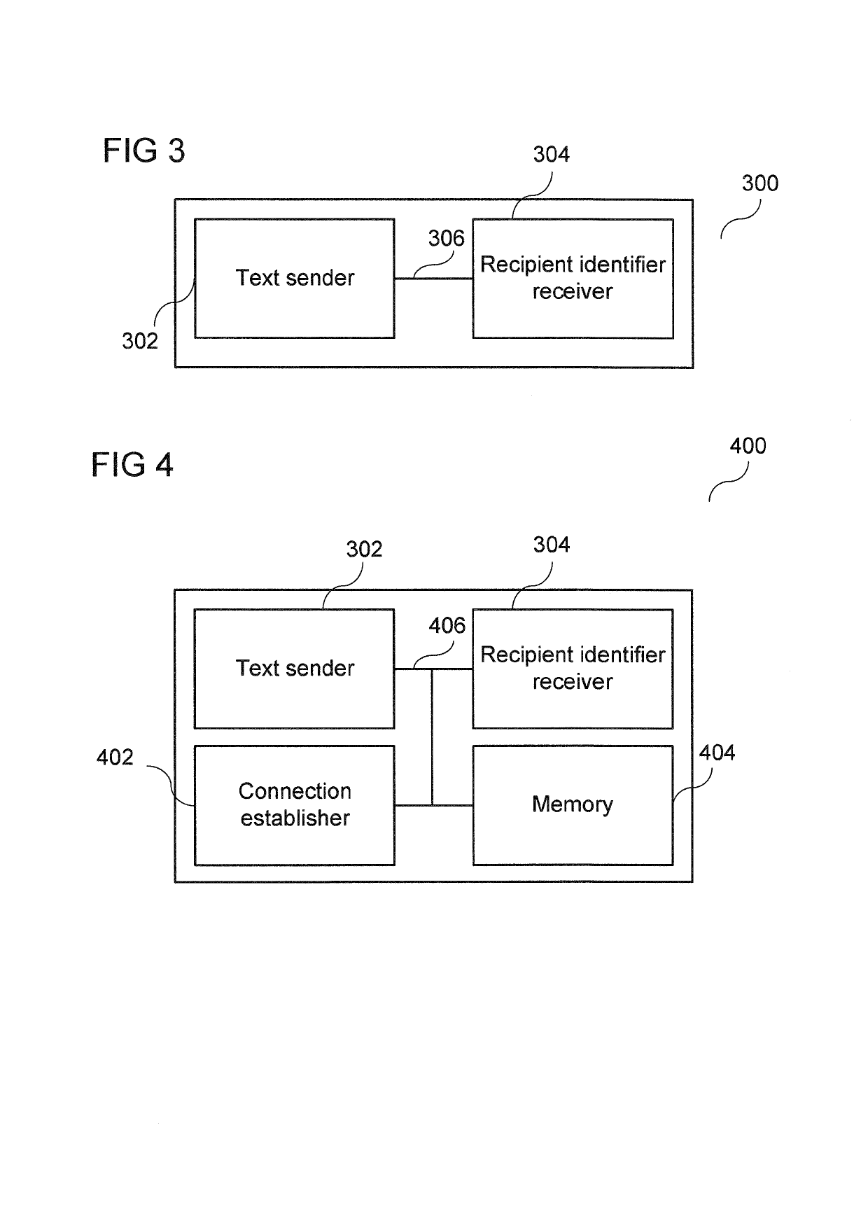

FIG. 3 shows a communication end device 300 in accordance with an aspect of this disclosure. The communication end device 300 may include a text sender 302 (or a text sending circuit 302) configured to send text via a communication protocol to a network device (not shown) of a network (not shown). The communication end device 300 may further include a recipient identifier receiver 304 (or a recipient identifier receiver circuit 304) configured to receive a recipient identifier from the network device in response to the sent text. The communication protocol may be configured to exchange information only between communication end devices of the network and network devices of the network. The text sender 302 and the recipient identifier receiver 304 may be coupled with each other, e.g. via a connection 306, for example an optical connection or an electrical connection, such as e.g. a cable or a computer bus or via any other suitable electrical connection to exchange electrical signals.

In an aspect of this disclosure, the communication protocol may further be configured to exchange information between a plurality of network devices of the network.

FIG. 4 shows a communication end device 400 in accordance with an aspect of this disclosure. The communication end device 400 may, similar to the communication end device 300 of FIG. 3, include a text sender 302 configured to send text via a communication protocol to a network device (not shown) of a network (not shown). The communication end device 400 may further, similar to the communication end device 300 of FIG. 3, include a recipient identifier receiver 304 configured to receive a recipient identifier from the network device in response to the sent text. The communication end device 400 may further include a connection establisher 402 (or a connection establishing circuit 402), like will be described in more detail below. The communication end device 400 may further include a memory 404, like will be described in more detail below. The communication protocol may be configured to exchange information only between communication end devices of the network and network devices of the network. The text sender 302, the recipient identifier receiver 304, the connection establisher 402, and the memory 404 may be coupled with each other, e.g. via a connection 406, for example an optical connection or an electrical connection, such as e.g. a cable or a computer bus or via any other suitable electrical connection to exchange electrical signals.

In an aspect of this disclosure, the communication protocol may further be configured to exchange information between a plurality of network devices of the network.

In an aspect of this disclosure, the connection establisher 402 may be configured to establish a connection with the recipient based on the received recipient information.

In an aspect of this disclosure, the memory 404 may be configured to store the received recipient information.

In an aspect of this disclosure, the communication protocol may be a protocol for unstructured supplementary service data.

In an aspect of this disclosure, the communication protocol may further be configured to exchange at least one of symbolic data and control data.

In an aspect of this disclosure, the communication protocol may be a transport layer protocol.

In an aspect of this disclosure, the communication protocol may be an application layer protocol.

In an aspect of this disclosure, the network device may only be accessible by an operator of the network.

FIG. 5 shows a flow diagram 500 illustrating a method for controlling a network device in accordance with an aspect of this disclosure. In 502, text may be received from a communication end device via a communication protocol. In 504, recipient identifiers may be stored in a memory in relation to textual names. In 506, a recipient identifier may be acquired from the memory based on the received text. The communication protocol may be configured to exchange information only between communication end devices of the network and network devices of the network.

In an aspect of this disclosure, the communication protocol may further be configured to exchange information between a plurality of network devices of the network.

In an aspect of this disclosure, the method may further include determining a domain to which the recipient belongs.

In an aspect of this disclosure, the method may further include determining whether the recipient belongs to a telephone domain or to an internet domain.

In an aspect of this disclosure, the telephone domain may be one of a domain of a public land mobile network and a domain of a public switched telephone network.

In an aspect of this disclosure, the internet domain may be a domain of a session initiation protocol communication.

In an aspect of this disclosure, the method may further include establishing a connection with the recipient.

In an aspect of this disclosure, the method may further include establishing the connection based on the determined domain.

In an aspect of this disclosure, the communication protocol may be a protocol for unstructured supplementary service data.

In an aspect of this disclosure, the communication protocol may further be configured to exchange at least one of symbolic data and control data.

In an aspect of this disclosure, the communication protocol may be a transport layer protocol.

In an aspect of this disclosure, the communication protocol may be an application layer protocol.

In an aspect of this disclosure, the network device may only be accessible by an operator of the network.

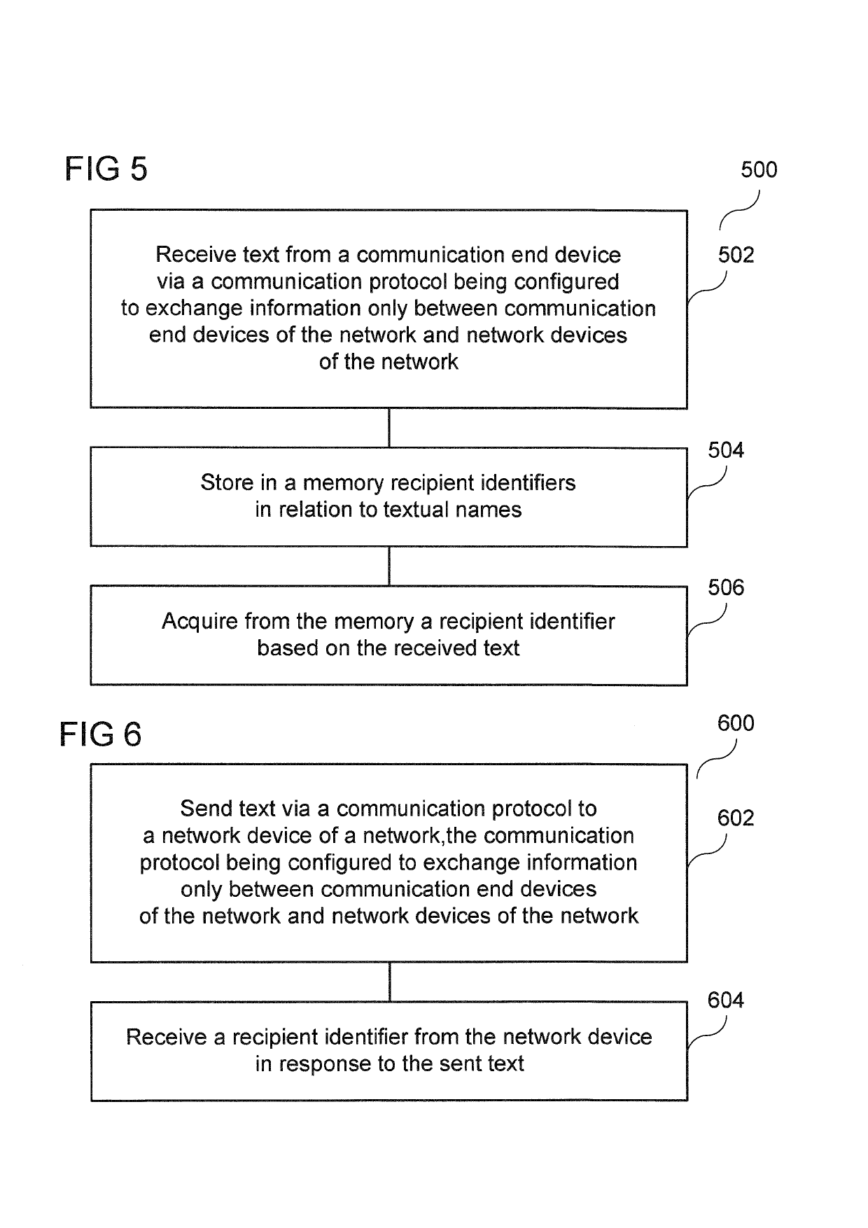

FIG. 6 shows a flow diagram 600 illustrating a method for controlling a communication end device in accordance with an aspect of this disclosure. In 602, text may be sent via a communication protocol to a network device of a network. In 604, a recipient identifier may be received from the network device in response to the sent text. The communication protocol may be configured to exchange information only between communication end devices of the network and network devices of the network.

In an aspect of this disclosure, the communication protocol may further be configured to exchange information between a plurality of network devices of the network.

In an aspect of this disclosure, the method may further include establishing a connection with the recipient based on the received recipient information.

In an aspect of this disclosure, the method may further include storing in a memory the received recipient information.

In an aspect of this disclosure, the communication protocol may be a protocol for unstructured supplementary service data.

In an aspect of this disclosure, the communication protocol may be further configured to exchange at least one of symbolic data and control data.

In an aspect of this disclosure, the communication protocol may be a transport layer protocol.

In an aspect of this disclosure, the communication protocol may be an application layer protocol.

In an aspect of this disclosure, the network device may only be accessible by an operator of the network.

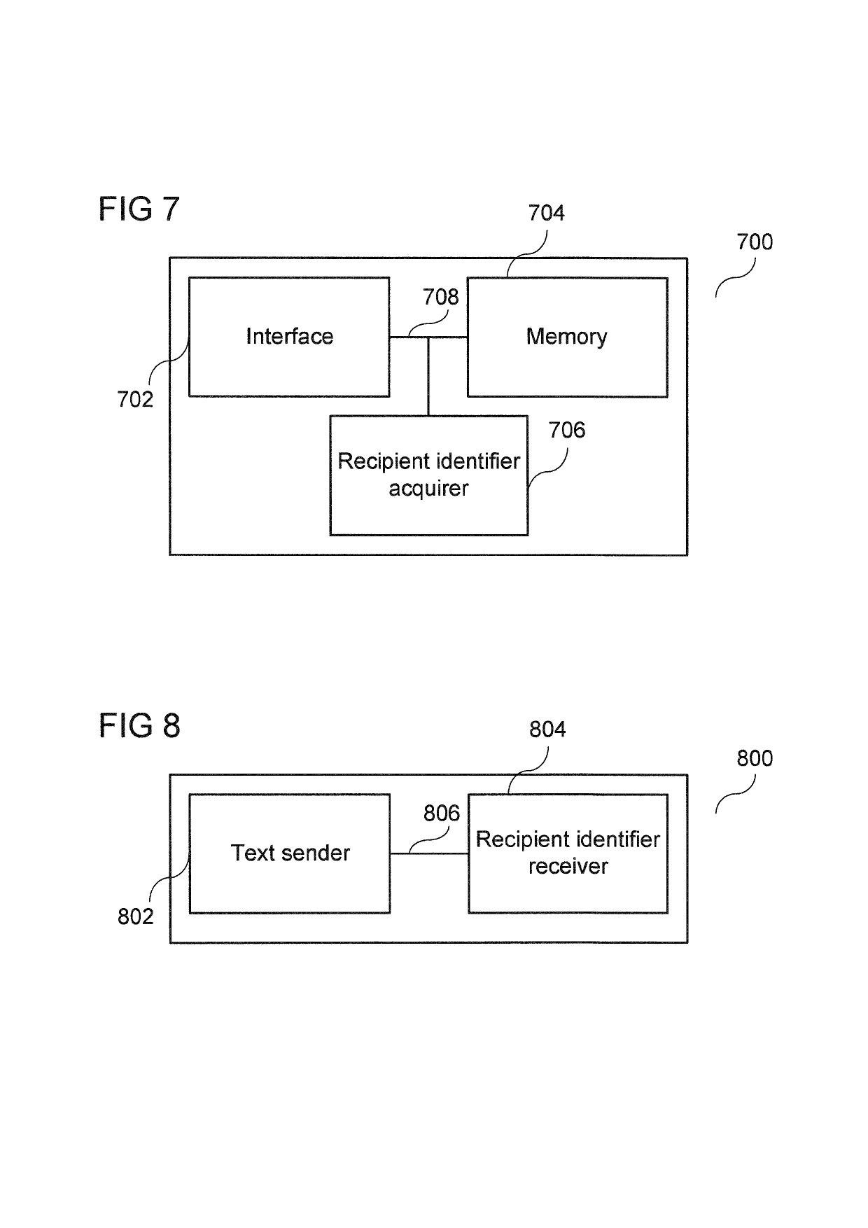

FIG. 7 shows a network device 700 in accordance with an aspect of this disclosure. The network device 700 may be a network device of a network. The network device 700 may include an interface 702 configured to receive text from a communication end device via unstructured supplementary service data. The network device 700 may further include a memory 704 configured to store recipient identifiers in relation to textual names. The network device 700 may include a recipient identifier acquirer 706 configured to acquire from the memory a recipient identifier based on the received text. The interface 702, the memory 704 and the recipient identifier acquirer 706 may be coupled with each other, e.g. via a connection 708, for example an optical connection or an electrical connection, such as e.g. a cable or a computer bus or via any other suitable electrical connection to exchange electrical signals.

FIG. 8 shows a communication end device 800 in accordance with an aspect of this disclosure. The communication end device 800 may include a text sender 802 configured to send text via unstructured supplementary service data to a network device of a network. The communication end device 800 may further include a recipient identifier receiver 804 configured to receive a recipient identifier from the network device in response to the sent text. The text sender 802 and the recipient identifier receiver 804 may be coupled with each other, e.g. via a connection 806, for example an optical connection or an electrical connection, such as e.g. a cable or a computer bus or via any other suitable electrical connection to exchange electrical signals.

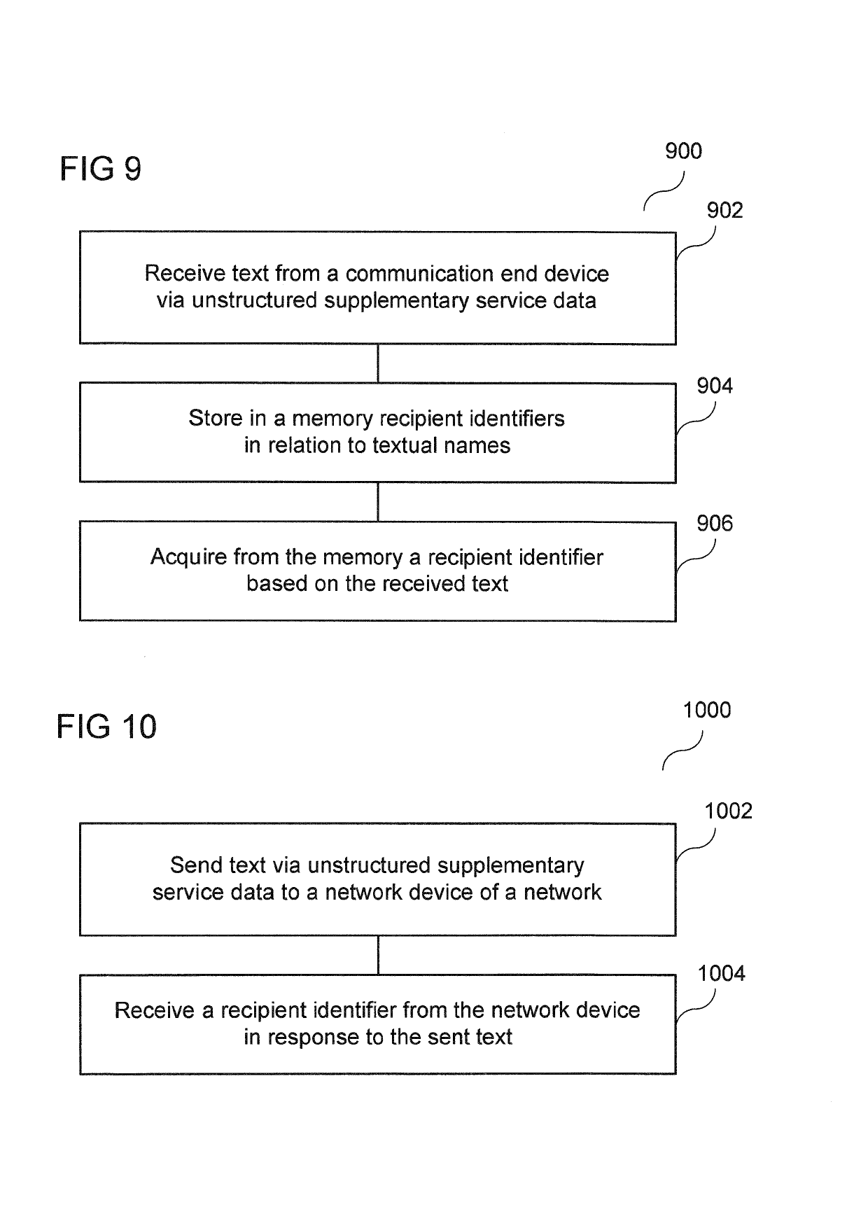

FIG. 9 shows a flow diagram 900 illustrating a method for controlling a network device in accordance with an aspect of this disclosure. In 902, text may be received from a communication end device via unstructured supplementary service data. In 904, recipient identifiers may be stored in a memory in relation to textual names. In 906, a recipient identifier may be acquired from the memory based on the received text.

FIG. 10 shows a flow diagram 1000 illustrating a method for controlling a communication end device in accordance with an aspect of this disclosure. In 1002, text may be sent via unstructured supplementary service data to a network device of a network. In 1004, a recipient identifier may be received from the network device in response to the sent text.

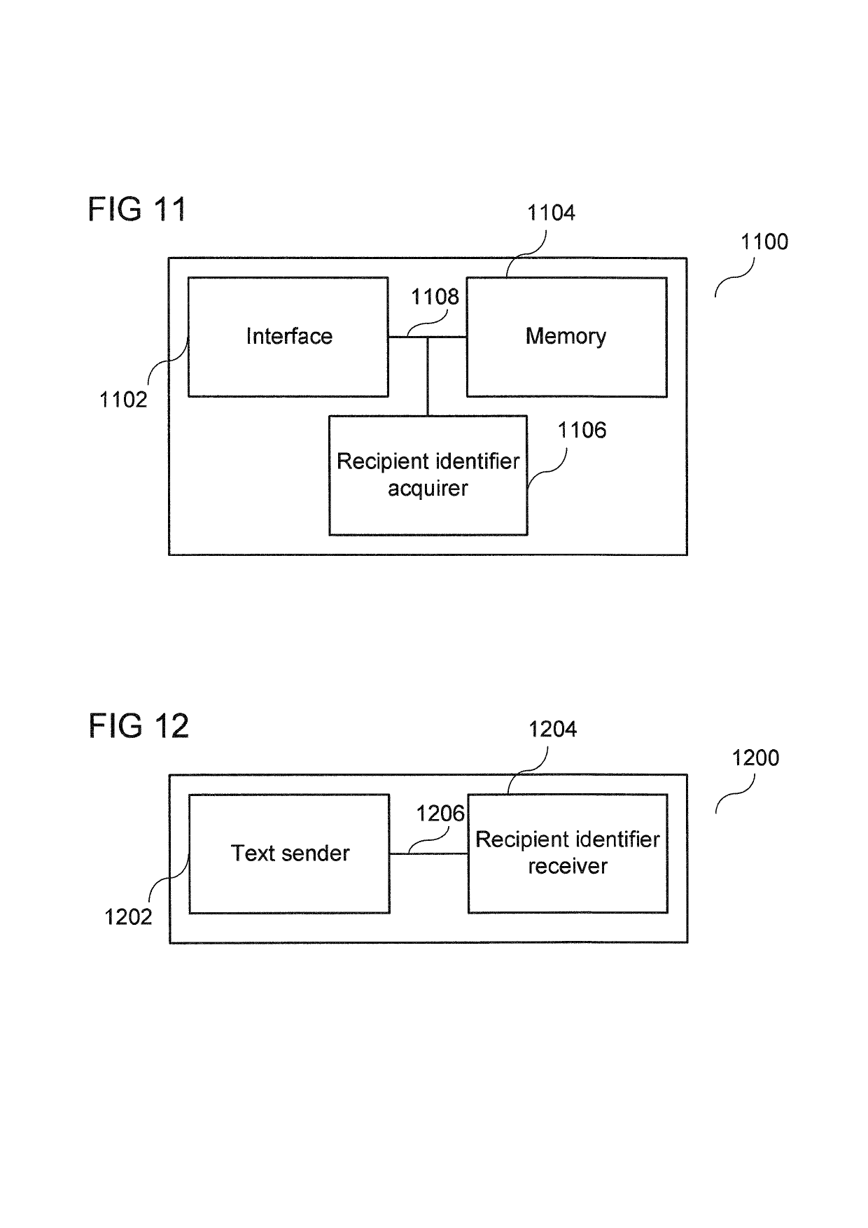

FIG. 11 shows a network device 1100 in accordance with an aspect of this disclosure. The network device 1100 may be a network device of a network. The network device 1100 may include an interface 1102 configured to receive text from a communication end device (not shown) via a communication protocol. The network device 1100 may further include a memory 1104 configured to store recipient identifiers in relation to textual names. The network device 1100 may further include a recipient identifier acquirer 1106 configured to acquire from the memory a recipient identifier based on the received text. The communication protocol may be configured to exchange at least one of symbolic data and control data. The interface 1102, the memory 1104 and the recipient identifier acquirer 1106 may be coupled with each other, e.g. via a connection 1108, for example an optical connection or an electrical connection, such as e.g. a cable or a computer bus or via any other suitable electrical connection to exchange electrical signals.

FIG. 12 shows a communication end device 1200 in accordance with an aspect of this disclosure. The communication end device 1200 may include a text sender 1202 configured to send text via a communication protocol to a network device (not shown) of a network. The communication end device 1200 may further include a recipient identifier receiver 1204 configured to receive a recipient identifier from the network device in response to the sent text. The communication protocol is configured to exchange at least one of symbolic data and control data. The text sender 1202 and the recipient identifier receiver 1204 may be coupled with each other, e.g. via a connection 1206, for example an optical connection or an electrical connection, such as e.g. a cable or a computer bus or via any other suitable electrical connection to exchange electrical signals.

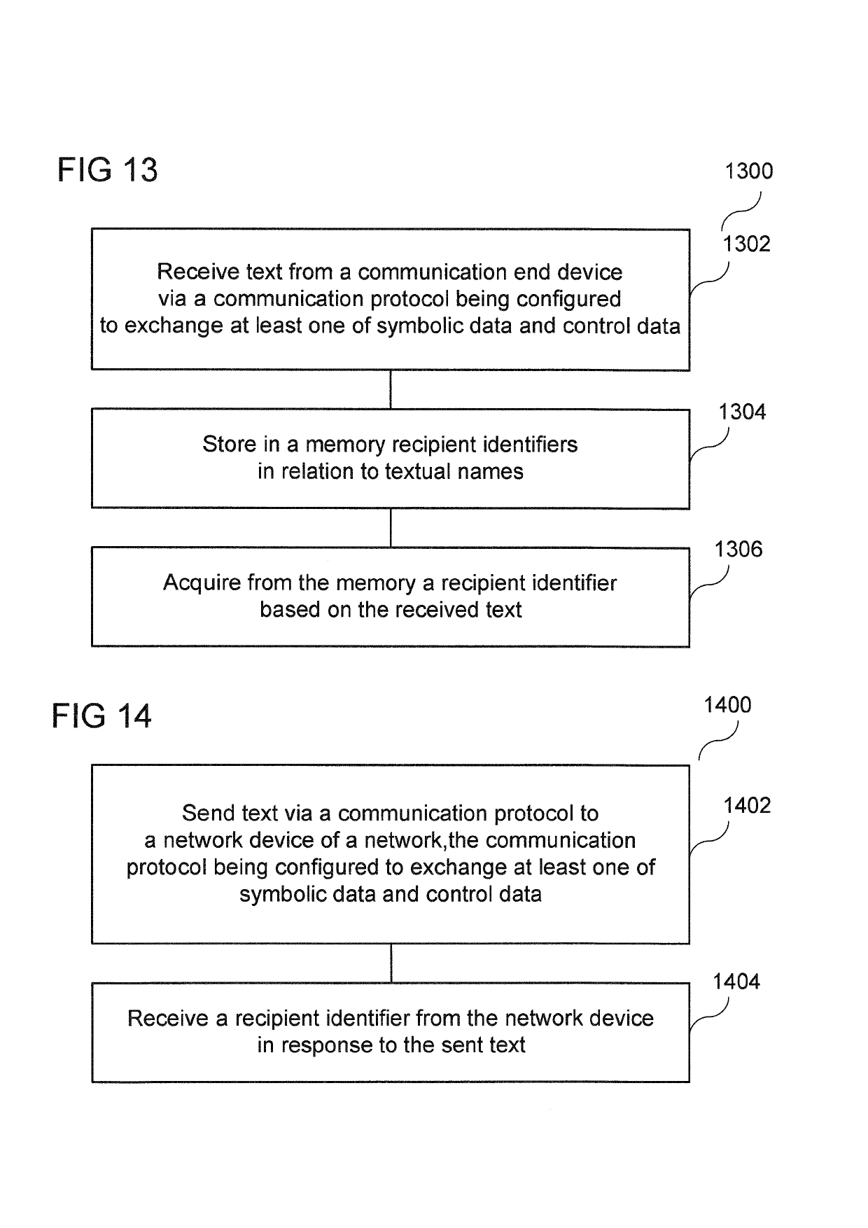

FIG. 13 shows a flow diagram 1300 illustrating a method for controlling a network device in accordance with an aspect of this disclosure. In 1302, text may be received from a communication end device via a communication protocol. In 1304, recipient identifiers may be stored in a memory in relation to textual names. In 1306, a recipient identifier may be acquired from the memory based on the received text. The communication protocol may be configured to exchange at least one of symbolic data and control data.

FIG. 14 shows a flow diagram 1400 illustrating a method for controlling a communication end device in accordance with an aspect of this disclosure. In 1402, text may be sent via a communication protocol to a network device of a network. In 1404, a recipient identifier may be received from the network device in response to the sent text. The communication protocol is configured to exchange at least one of symbolic data and control data.

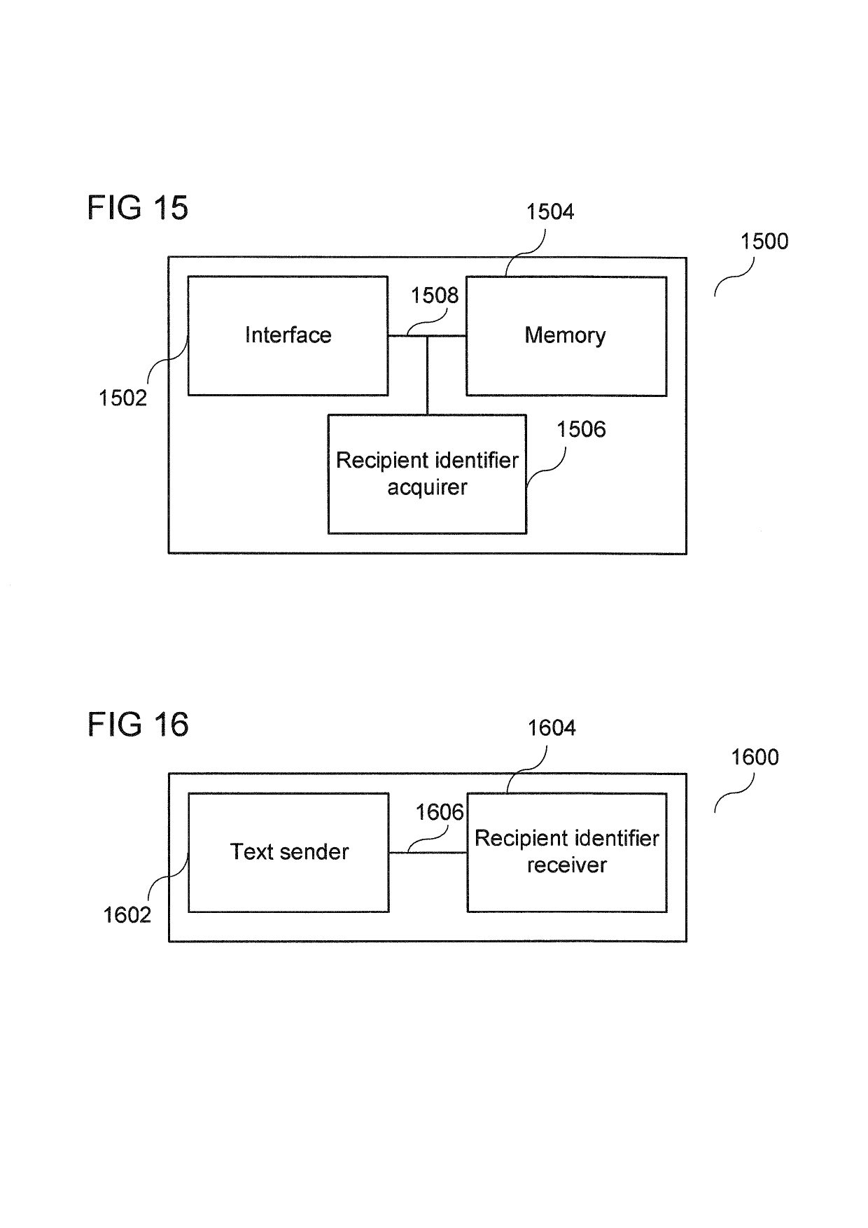

FIG. 15 shows a network device 1500 in accordance with an aspect of this disclosure. The network device 1500 may be a network device of a network. The network device 1500 may only be accessible by an operator of the network. The network device 1500 may include an interface 1502 configured to receive text from a communication end device (not shown). The network device 1500 may further include a memory 1504 configured to store recipient identifiers in relation to textual names. The network device 1500 may further include a recipient identifier acquirer 1506 configured to acquire from the memory a recipient identifier based on the received text. The interface 1502, the memory 1504 and the recipient identifier acquirer 1506 may be coupled with each other, e.g. via a connection 1508, for example an optical connection or an electrical connection, such as e.g. a cable or a computer bus or via any other suitable electrical connection to exchange electrical signals.

FIG. 16 shows a communication end device 1600 in accordance with an aspect of this disclosure. The communication end device 1600 may include a text sender 1602 configured to send text to a network device (not shown) of a network (not shown). The network device may be a network device which is only accessible by an operator of the network. The communication end device 1600 may further include a recipient identifier receiver 1604 configured to receive a recipient identifier from the network device in response to the sent text. The text sender 1602 and the recipient identifier receiver 1604 may be coupled with each other, e.g. via a connection 1606, for example an optical connection or an electrical connection, such as e.g. a cable or a computer bus or via any other suitable electrical connection to exchange electrical signals.

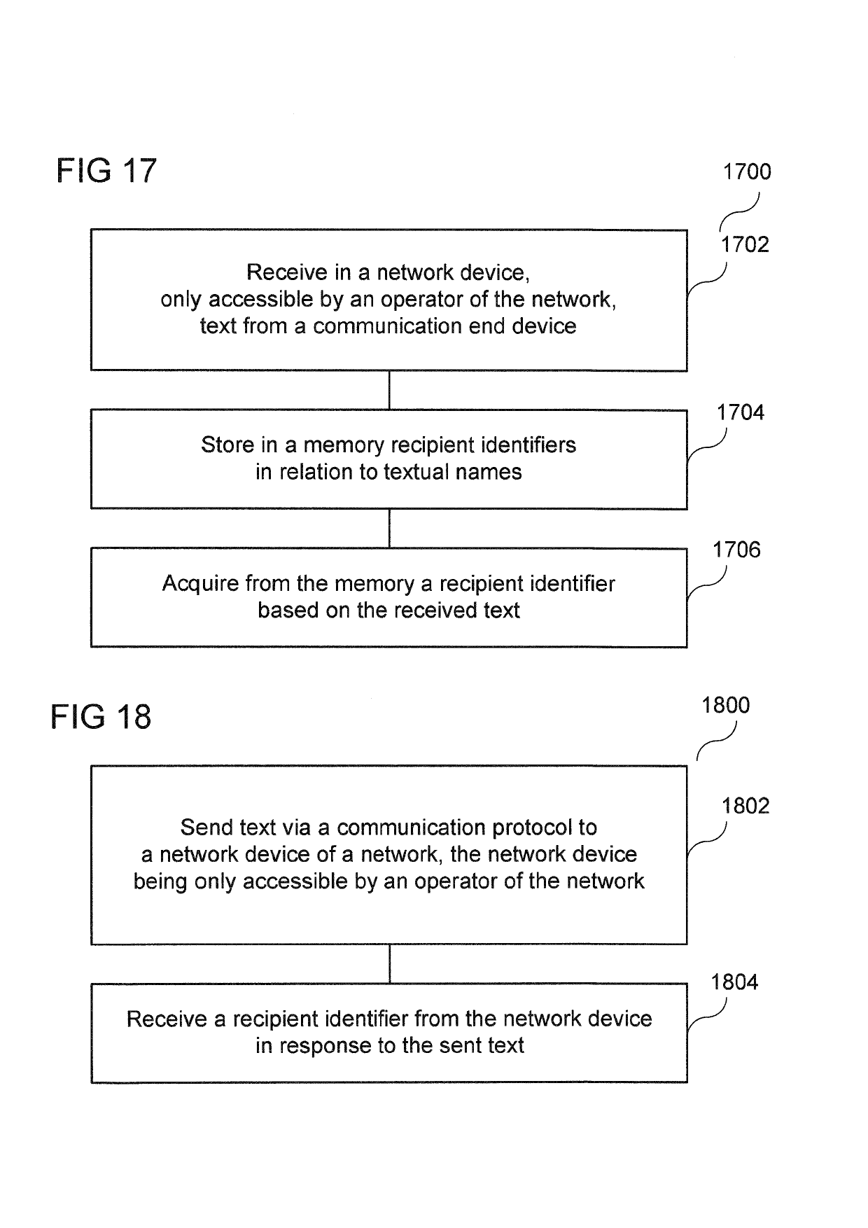

FIG. 17 shows a flow diagram 1700 illustrating a method for controlling a network device in accordance with an aspect of this disclosure. The network device may be only accessible by an operator of the network. In 1702, text may be received from a communication end device. In 1704, recipient identifiers may be stored in a memory in relation to textual names. In 1706, a recipient identifier may be acquired from the memory based on the received text.

FIG. 18 shows a flow diagram 1800 illustrating a method for controlling a communication end device in accordance with an aspect of this disclosure. In 1802, text may be sent to a network device of a network, wherein the network device may be a network device which is only accessible by an operator of the network. In 1804, a recipient identifier may be received from the network device in response to the sent text.

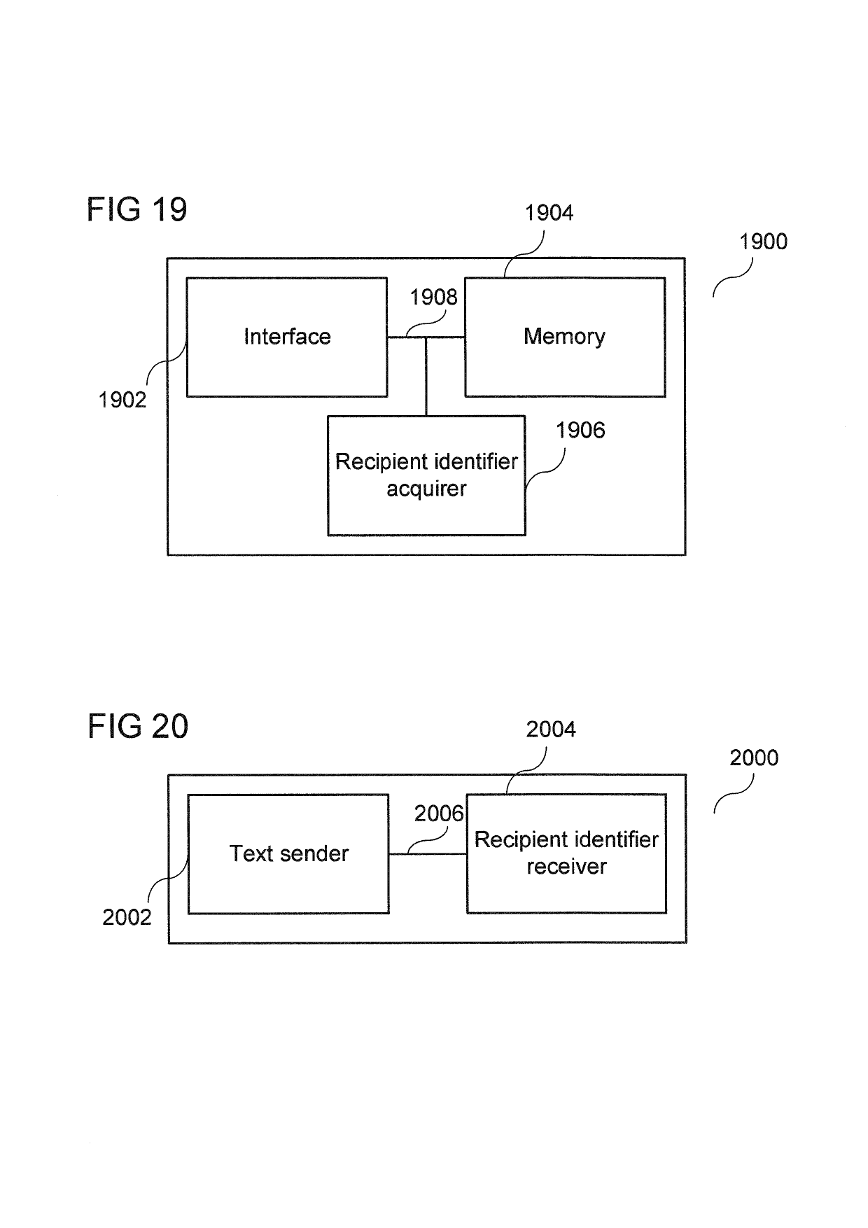

FIG. 19 shows a network device 1900 in accordance with an aspect of this disclosure. The network device 1900 may be a network device of a network. The network device 1900 may include an interface 1902 configured to receive text from a communication end device via a communication protocol. The network device 1900 may further include a memory 1904 configured to store recipient identifiers in relation to textual names. The network device 1900 may further include a recipient identifier acquirer 1906 configured to acquire from the memory a recipient identifier based on the received text. The communication protocol may be a transport layer protocol. The interface 1902, the memory 1904 and the recipient identifier acquirer 1906 may be coupled with each other, e.g. via a connection 1908, for example an optical connection or an electrical connection, such as e.g. a cable or a computer bus or via any other suitable electrical connection to exchange electrical signals.

FIG. 20 shows a communication end device 2000 in accordance with an aspect of this disclosure. The communication end device 2000 may include a text sender 2002 configured to send text via a communication protocol to a network device of a network. The communication end device 2000 may further include a recipient identifier receiver 2004 configured to receive a recipient identifier from the network device in response to the sent text. The communication protocol may be a transport layer protocol. The text sender 2002 and the recipient identifier receiver 2004 may be coupled with each other, e.g. via a connection 2006, for example an optical connection or an electrical connection, such as e.g. a cable or a computer bus or via any other suitable electrical connection to exchange electrical signals.

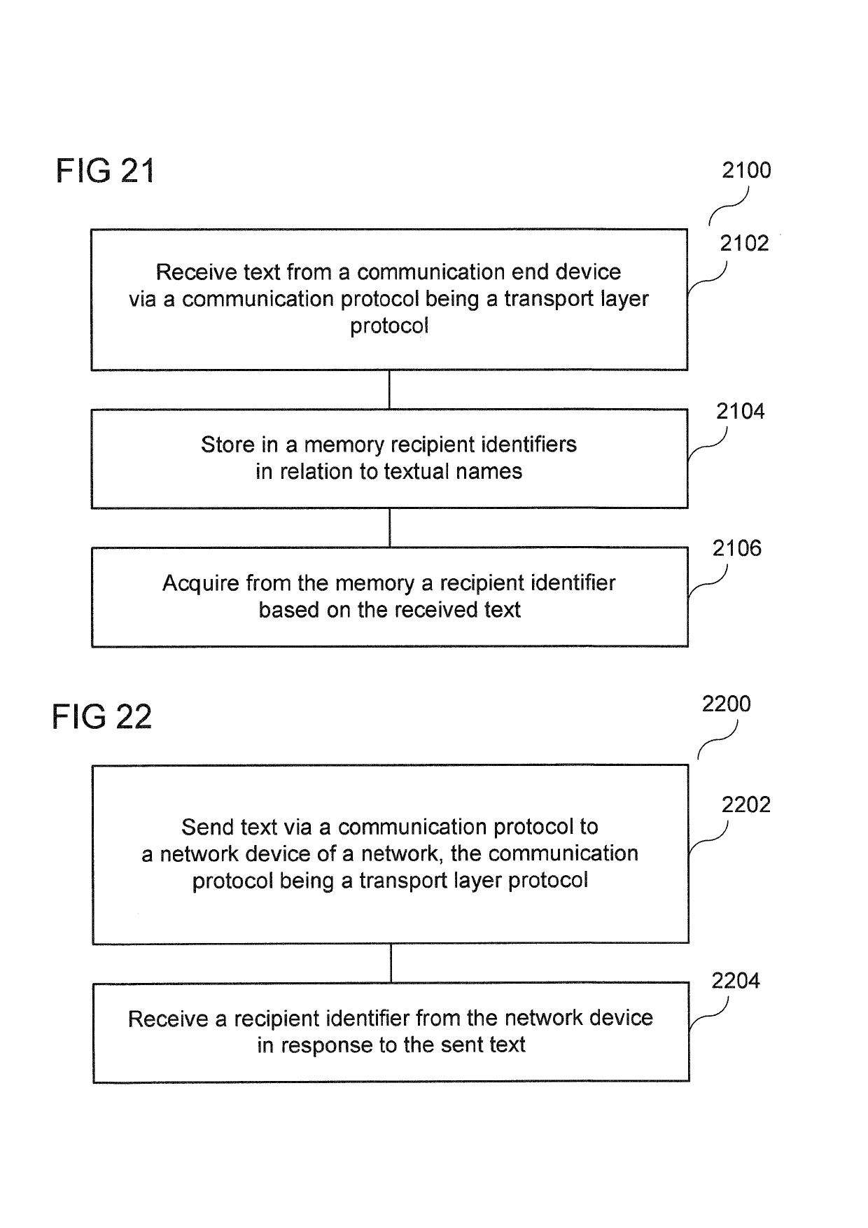

FIG. 21 shows a flow diagram 2100 illustrating a method for controlling a network device in accordance with an aspect of this disclosure. In 2102, text may be received from a communication end device via a communication protocol. In 2104, recipient identifiers may be stored in a memory in relation to textual names. In 2106, a recipient identifier may be acquired from the memory based on the received text. The communication protocol may be a transport layer protocol.

FIG. 22 shows a flow diagram 2200 illustrating a method for controlling a communication end device in accordance with an aspect of this disclosure. In 2202, text may be sent via a communication protocol to a network device of a network. In 2204, a recipient identifier may be received from the network device in response to the sent text. The communication protocol may be a transport layer protocol.

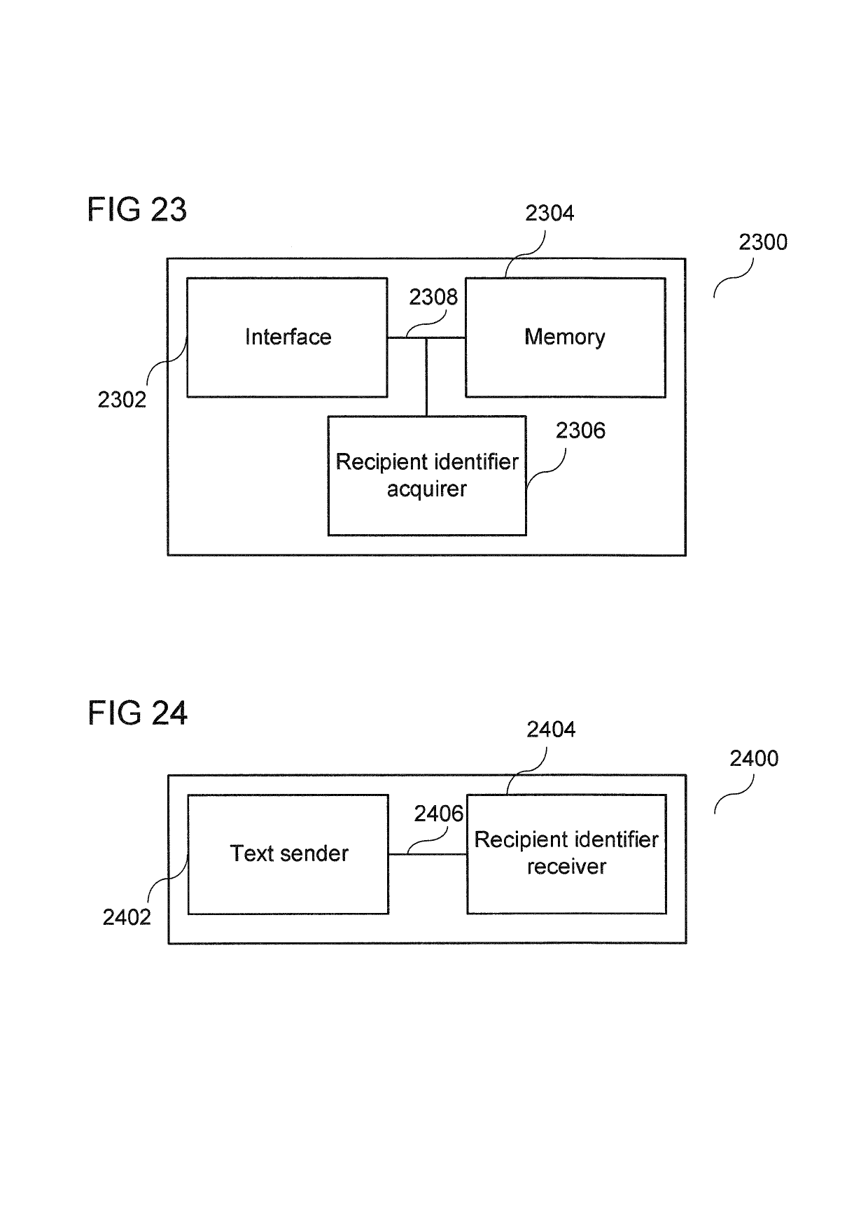

FIG. 23 shows a network device 2300 in accordance with an aspect of this disclosure. The network device 2300 may be a network device of a network. The network device 2300 may include an interface 2302 configured to receive text from a communication end device via a communication protocol. The network device 2300 may further include a memory 2304 configured to store recipient identifiers in relation to textual names. The network device 2300 may further include a recipient identifier acquirer 2306 configured to acquire from the memory a recipient identifier based on the received text. The communication protocol may be an application layer protocol. The interface 2302, the memory 2304 and the recipient identifier acquirer 2306 may be coupled with each other, e.g. via a connection 2308, for example an optical connection or an electrical connection, such as e.g. a cable or a computer bus or via any other suitable electrical connection to exchange electrical signals.

FIG. 24 shows a communication end device 2400 in accordance with an aspect of this disclosure. The communication end device 2400 may include a text sender 2402 configured to send text via a communication protocol to a network device of a network. The communication end device 2400 may further include a recipient identifier receiver 2404 configured to receive a recipient identifier from the network device in response to the sent text. The communication protocol may be an application layer protocol. The text sender 2402 and the recipient identifier receiver 2404 may be coupled with each other, e.g. via a connection 2406, for example an optical connection or an electrical connection, such as e.g. a cable or a computer bus or via any other suitable electrical connection to exchange electrical signals.

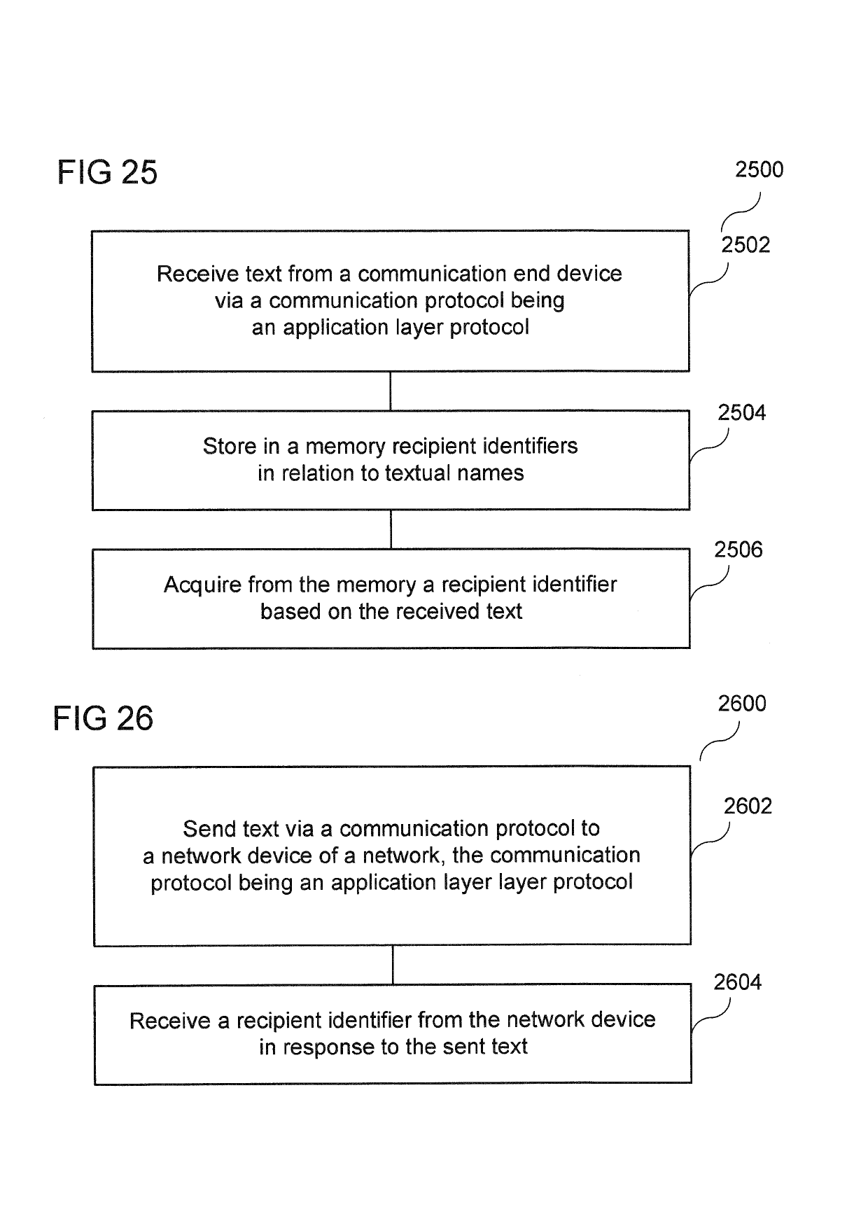

FIG. 25 shows a flow diagram 2500 illustrating a method for controlling a network device in accordance with an aspect of this disclosure. In 2502, text may be received from a communication end device via a communication protocol. In 2504, recipient identifiers may be stored in a memory in relation to textual names. In 2506, a recipient identifier may be acquired from the memory based on the received text. The communication protocol may be an application layer protocol.

FIG. 26 shows a flow diagram 2600 illustrating a method for controlling a communication end device in accordance with an aspect of this disclosure. In 2602, text may be sent via a communication protocol to a network device of a network. In 2604, a recipient identifier may be received from the network device in response to the sent text. The communication protocol may be an application layer protocol.

In an aspect of this disclosure, devices and methods may be provided for use of USSD for call initiation.

In an aspect of this disclosure, devices and methods may be provided for handling of USSD call initiation requests depending on the type of address included (for example included in USSD for call initiation).

In an aspect of this disclosure, devices and methods may be provided for a definition of an association between symbolic address and dialing number in the addressed device's home network.

In an aspect of this disclosure, devices and methods may be provided, wherein a dialing number is associated with an address to an end device.

In an aspect of this disclosure, devices and methods may be provided, wherein call initiation may trigger call back of a caller.

In an aspect of this disclosure, devices and methods may be provided for dialing in Public Land Mobile Networks (PLMN).

In an aspect of this disclosure, devices and methods may be provided for enabling symbolic dialing in PLMNs. Symbolic dialing may mean using symbolic address strings (in other words: textual names) instead of dialing numbers.

In an aspect of this disclosure, devices and methods may be provided for symbolic addresses for PLMN end devices.

In an aspect of this disclosure, devices and methods may be provided for symbolic addresses for PSTN (Public Switched Telephone Network) end devices.

In an aspect of this disclosure, symbolic PLMN/PSTN addresses may be used without knowing the corresponding dialing numbers.

In an aspect of this disclosure, devices and methods may be provided which may be used for reaching internet based communication services (like VolP (voice over IP (Internet Protocol))).

In an aspect of this disclosure, devices and methods may be provided which may be used with IMS (IP Multimedia Subsystem) services.

In an aspect of this disclosure, devices and methods may be provided which may be used with IMS Network-Independent Public User Identities (INIPUI).

In an aspect of this disclosure, devices and methods may be provided which may be used with existing end devices.

In an aspect of this disclosure, devices and methods may be provided for transparent user experience.

In an aspect of this disclosure, devices and methods may not need new protocols or protocol extensions.

In an aspect of this disclosure, Internet based communication services may use symbolic addresses. For example, SIP (Session Initiation Protocol) based services like VoIP (Voice over IP) and Email may use symbolic addresses.

In an aspect of this disclosure, the IP Multimedia Subsystem (IMS) may be based on SIP and may be using symbolic SIP addresses.

In an aspect of this disclosure, IMS SIP addresses may indicate the service providing operator's domain. In an aspect of this disclosure, in accordance with 3GPP (Third Generation Partnership Project), IMS Network-Independent Public User Identities (INIPUI) may be provided that do not indicate the operator's domain.

In an aspect of this disclosure, unstructured supplementary service data (USSD) may be exchanged between PLMN communication end devices and their networks.

In an aspect of this disclosure, in USSD Man Machine Interface mode (MMI mode), the transmitted data may be used to exchange generic information between end devices and networks. For example, an end device may transmit data to request special information from the network and the network may transmit information data to be displayed by the end device.

In an aspect of this disclosure, in USSD application mode, the transmitted data may be used to exchange application specific information between end devices and networks. For example, information may be exchanged for controlling a network based voice mail box.

In an aspect of this disclosure, a USSD message may include (or contain) up to 182 characters, and each character may be a 7 bit character.

In an aspect of this disclosure, USSD data may be concatenated.

In an aspect of this disclosure, USSD data may be immediately transmitted (without store and forward).

In an aspect of this disclosure, USSD may be used for initiating PLMN calls using symbolic addresses.

In an aspect of this disclosure, PLMN end devices may dial symbolic addresses (in other words: may include other characters besides numbers; in other words: may be textual names).

In an aspect of this disclosure, PLMN end device addresses may be symbolic.

In an aspect of this disclosure, PSTN end device addresses may be symbolic.

In an aspect of this disclosure, symbolic PLMN/PSTN addresses may be used without knowing the corresponding dialing numbers.

In an aspect of this disclosure, devices and methods may be provided that may be used for reaching internet based communication services.

In an aspect of this disclosure, devices and methods may be provided that may be used with IMS services.

In an aspect of this disclosure, devices and methods may be provided that may be used with IMS Network-Independent Public User Identities (INIPUI).

In an aspect of this disclosure, PLMN interworking with IMS/internet services may not need interworking gateways in the IMS/internet service network.

In an aspect of this disclosure, multiple symbolic addresses may be associated with the same PLMN/PSTN dialing number.

In an aspect of this disclosure, symbolic addresses being dialed may be indicated to the callee.

In an aspect of this disclosure, symbolic addresses may be activated and/or deactivated independent of the end device state.

In an aspect of this disclosure, devices and methods may be provided that may be used with existing end devices.

In an aspect of this disclosure, transparent user experience may be provided.

In an aspect of this disclosure, no new protocols or protocol extensions may be needed.

In an aspect of this disclosure, USSD may be used for initiating PLMN calls using symbolic addresses, wherein symbolic addresses may be sent from PLMN end devices to the visited or home network via USSD. The visited network's USSD application or the home network's USSD application may handle the USSD message depending on the type of included symbolic target address.

In an aspect of this disclosure, if the target address belongs to a PLMN/PSTN domain, then the USSD application may request the associated dialing number from the target PLMN/PSTN.

In an aspect of this disclosure, the USSD application may either send another USSD message including the associated dialing number back to the PLMN end device or it may dial the associated dialing number on behalf of the PLMN end device.

In an aspect of this disclosure, associations between symbolic addresses and dialing numbers may be defined by the user and PLMN who own the dialing number.

In an aspect of this disclosure, if the target address belongs to an internet domain (for example if the address is a SIP address), then the USSD application may set up a corresponding internet connection to the target domain on behalf of the PLMN end device.

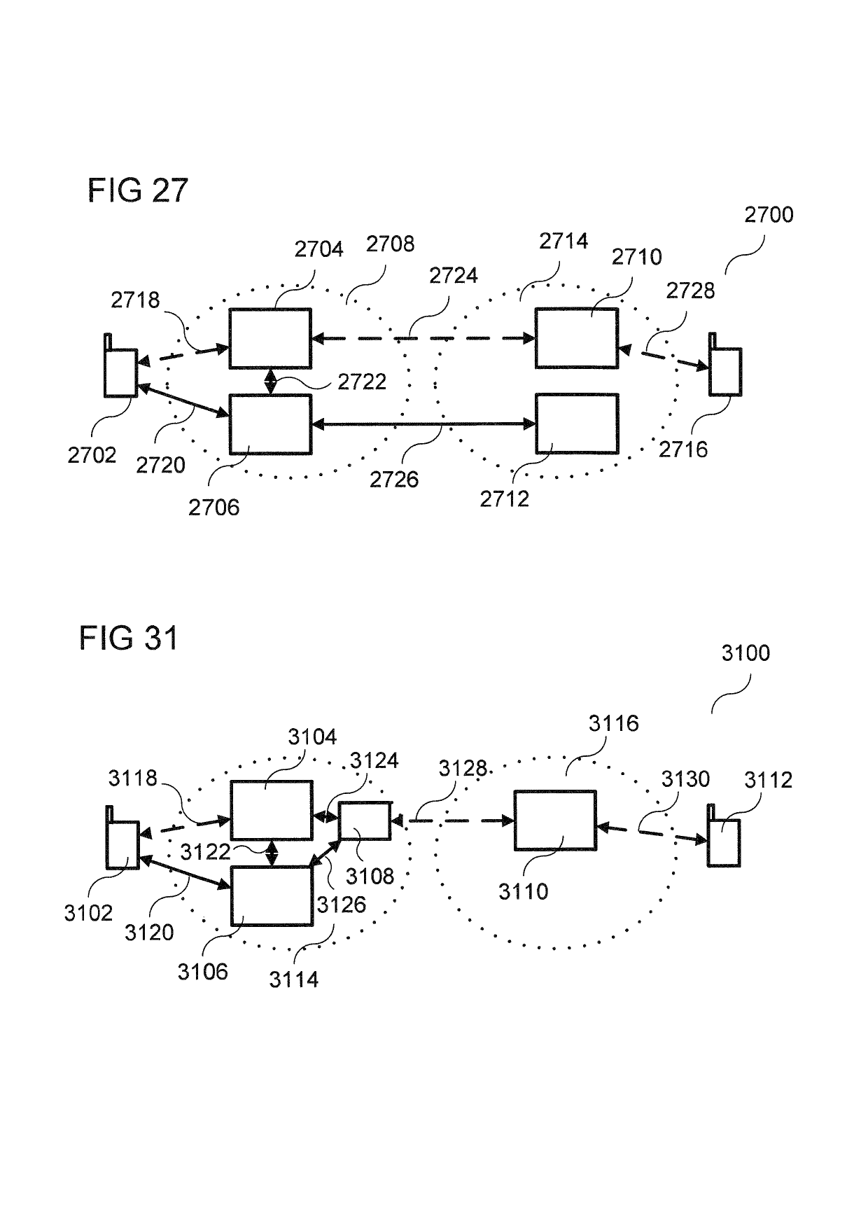

FIG. 27 shows a network architecture 2700 in accordance with an aspect of this disclosure. The network architecture 2700 may be a simplified PLMN architecture. A first end device (in other words: a first communication end device) 2702 (which may also be referred to as T1) of a first user U1, a second end device 2716 (which may also be referred to as T2) of a second user U2, a V-PLMN (visited PLMN) 2708, and a T-PLMN (target PLMN) 2714 may be provided. In the V-PLMN 2708, a V-US (visited USSD application server) 2706 and a V-MSC (visited MSC (Mobile Switching Center)) 2704 may be provided. In the T-PLMN 2714, a T-US (target USSD application server) 2712 and a T-MSC (target MSC) 2710 may be provided. The first end device 2702 may communicate with the V-MSC 2704, like indicated by a first arrow 2718. The first end device 2702 may communicate with the V-US 2706, like indicated by a second arrow 2720. The V-MSC 2704 and the V-US 2706 may communicate, like indicated by a third arrow 2722. The V-MSC 2704 and the T-MSC 2710 may communicate, like indicated by a fourth arrow 2724. The V-US 2706 and the T-US 2712 may communicate, like indicated by a fifth arrow 2726. The T-MSC 2710 and the second end device 2716 may communicate, like indicated by a sixth arrow 2728.

For example, it may be assumed that the PLMN end device 2702 (the first end device) is an end device, whose phone application does support PLMN symbolic dialing. The first end device 2702 may be connected to the visited PLMN V-PLMN 2708. The V-PLMN 2708 may be connected to the different target PLMN T-PLMN 2714, for example a PLMN of the other PLMN end device 2716 (the second end device 2716) that will be called. The V-PLMN 2708 and the T-PLMN 2714 both include an application server V-US 2706 and T-US 2712 for executing a USSD application and a Mobile Switching Center V-MSC 2704 and T-MSC 2710 for call control.

For example, the first user U1 may have got the second user's (U2's) symbolic PLMN address “xxx@operator”, wherein “xxx” may be a name of a user and “operator” may be a name of an operator or network, for example “Harry@vodafone.com”. The first user U1 may want to call the second user U2 using the symbolic address.

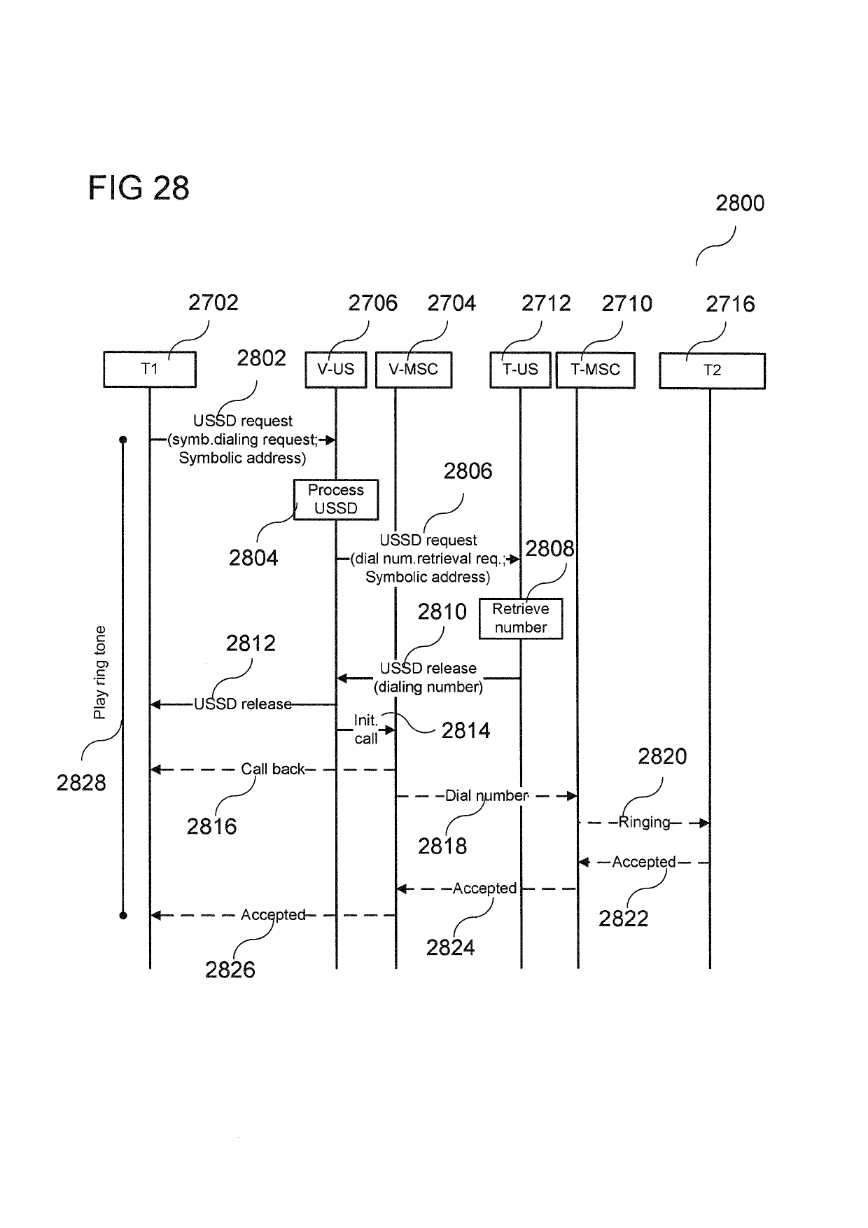

FIG. 28 shows a flow diagram 2800 illustrating a signaling flow in accordance with an aspect of this disclosure. For example, the flow diagram 2800 may show a signal flow for PLMN symbolic dialing in the network 2700 described in FIG. 27.

In an aspect of this disclosure, in 2802, the first end device 2702 (T1) may send a USSD message to the visited network. The USSD message may include a USSD code indicating the symbolic address call request. The USSD message may also include the symbolic address extended by the prefix “tel:” to indicate that the symbolic address should be used to call a phone. For example, the USSD string may be the following USSD string for requesting symbolic dialing:

*199*tel:xxx@operator#SEND

for example,

*199*tel:Harry@vodafone.com#SEND

In 2804, the visited network's USSD application may find the USSD code for symbolic address calling and may determine from the prefix of the included symbolic address that a phone number is being addressed. The USSD application may determine from the symbolic address domain part which PLMN is targeted by the address.

Then, in 2806, the USSD application may contact the target network, for example operated by the operator “operator”, for example the network “Vodafone”, per USSD requesting the dialing number associated with the symbolic address. The target network in 2810, after having retrieved the associated dialing number in 2808, may respond the associated dialing number in its USSD response. A USSD release may be send in 2812 to the first end device 2702.

After having received the response the V-PLMN's USSD application may call back the first user U1 (in other words: the first end device 2702 of the first user U1) by initiating a call in 2814. The V-MSC 2704 in 2816 and in 2818 may dial the received number on behalf of the first user U1. In 2820, ringing at the second end device 2716 may be provided. Then, the second end device 2716 may accept the call, and this may be indicated to the first end device 2702 in 2822, 2824 and 2826.

The phone application of the first user U1's end device T1 (the first end device 2702) may play a ringing tone in 2828, after sending its USSD request until it receives a message from the network indicating that the called second user U2 accepted the call.

The second user U2 beforehand may have defined the symbolic PLMN address to be associated with his PLMN number.

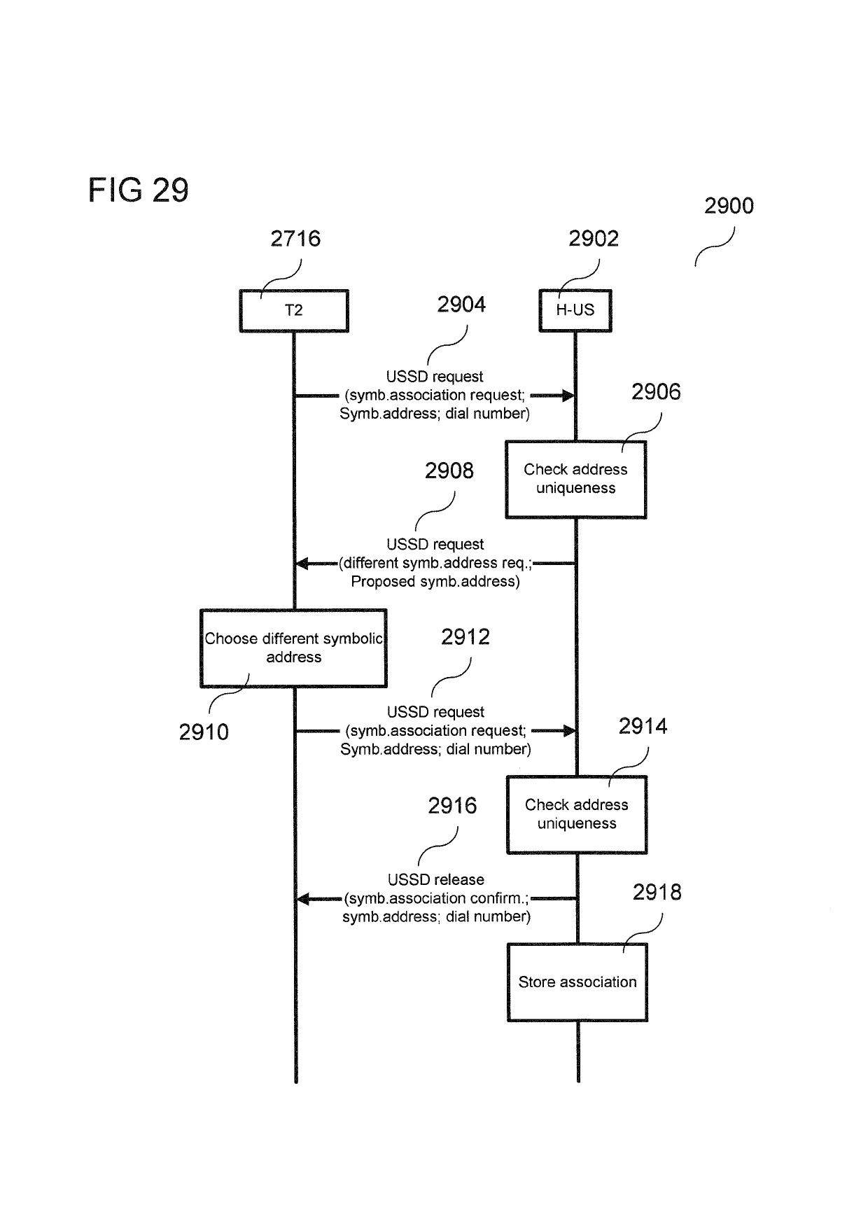

FIG. 29 shows a flow diagram 2900 illustrating a signaling flow in accordance with an aspect of this disclosure. The signaling flow shown in the flow diagram 2900 may be a signal flow for defining an association between a symbolic address and a dialing number. In 2904, the second user U2 may send a USSD message with a proposed symbolic address and including a USSD code for symbolic address association to his home network provider (for example Vodafone), for example to the USSD application server 2902 of U2's home network. The USSD string for defining an association between symbolic address and dialing number may be as follows:

*100*xxx;1234#SEND

for example

*100*Harry;1234#SEND

In 2906, the provider may verify that the symbolic address is unique (in other words: not yet used). If the address is not unique, then the network provider's USSD application may in 2908 request a different symbolic address and propose a particular address that is unique. The second user may then choose a different symbolic address in 2910. In 2912, the second user may send a USSD string for the different symbolic address to the USSD application server 2902 of his home network provider. In 2914, the provider may verify that the different symbolic address is unique.

If the symbolic address is unique, then, in 2916, the network provider's USSD application may send back a USSD response confirming the new symbolic address. In 2918, the network provider may store the symbolic address together with the associated dialing number for later lookup.

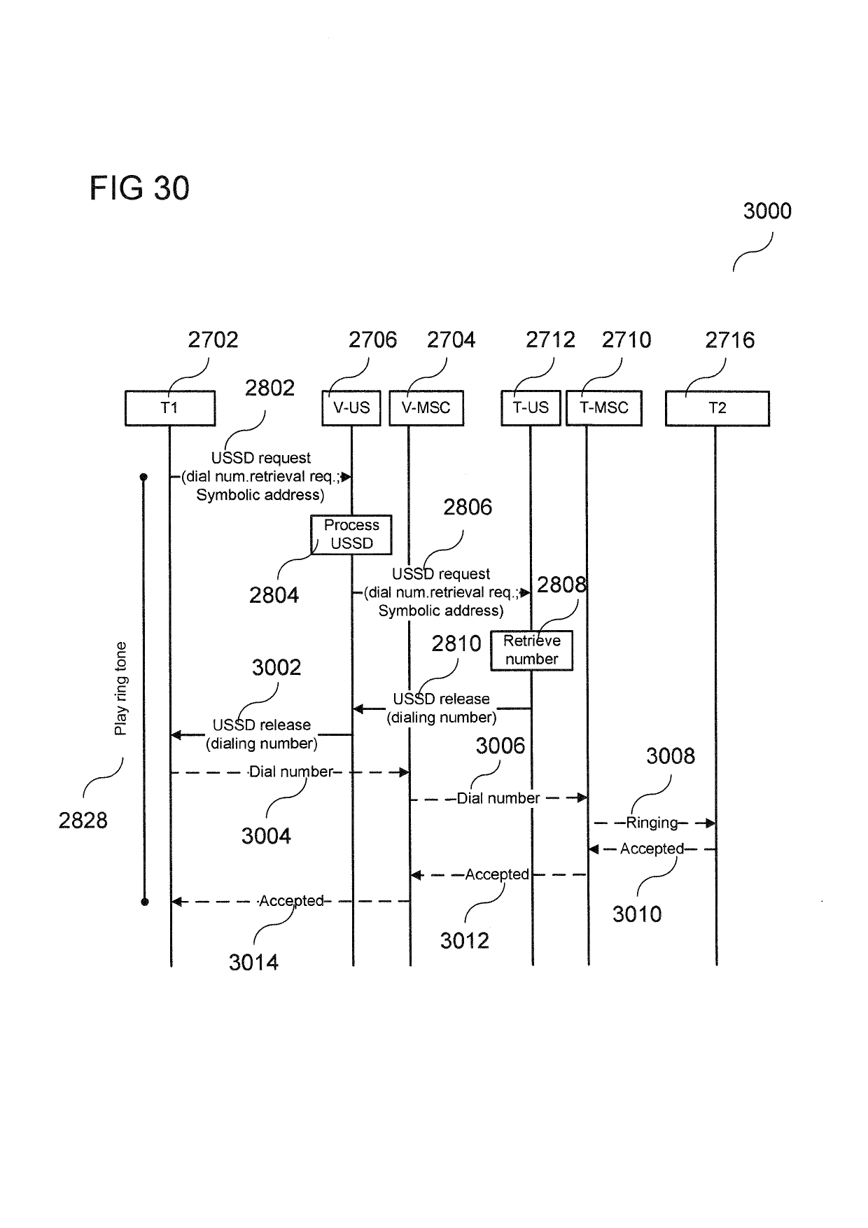

FIG. 30 shows a flow diagram 3000 illustrating a signaling flow in accordance with an aspect of this disclosure. In the flow diagram 3000 of PLMN symbolic dialing, some steps are identical or similar to the steps shown in the flow diagram 2800 of FIG. 28. For sake of brevity, duplicate description may be omitted and the same reference signs may be used. The architecture 2700 of FIG. 27 may be assumed. Also, the same situation and procedure as shown in the flow diagram 2800 of FIG. 28 may be assumed, until the V-PLMN USSD application 2706 receives in 2810 the USSD response from the target network that includes the associated dialing number.

After having received the response from the target network in 2810, the visited USSD application may forward the dialing number to user U1's end device T1 in its USSD response to the first end device 2702 in 3002. The first end device 2702 may then dial the received number in 3004 and 3006. In 3008, the second end device 2716 may be ringing. The phone application of User U1's end device T1 in 2828 then plays a ringing tone after sending its USSD request until the called second user U2 accepts the call in 3010, 3012 and 3014.

FIG. 31 shows a network architecture 3100 in accordance with an aspect of this disclosure. The network architecture 3100 may be a simplified PLMN and SIP network architecture. A first end device 3102 (T1) of a first user and a second end device 3112 (T2) of a second user U2 may be provided.

For example, it may be assumed that the first PLMN end device T1 3102 is an end device whose phone application does support PLMN symbolic dialing. The first end device 3102 may be connected to a visited PLMN V-PLMN 3114. The V-PLMN 3114 may include a USSD application server V-US 3106 and an MSC V-MSC 3104. The first end device 3102 may communicate with the V-MSC 3104, like indicated by a first arrow 3118. The first end device 3102 may communicate with the V-US 3106, like indicated by a second arrow 3120. The V-MSC 3104 and the V-US 3106 may communicate, like indicated by a third arrow 3122. The V-PLMN 3114 may furthermore include a VoIP interworking gateway IWG 3108, which may be connected to a target SIP call control server CCS 3110, like indicated by a fourth arrow 3128. The IWG 3108 may communicate with the V-MSC 3104, like indicated by a fifth arrow 3124. The IWG 3108 may communicate with the V-US 3106, like indicated by a sixth arrow 3126. The CCS 3110 may be provided in a target SIP (session initiation protocol) network 3116. The CSS 3110 and the second end device 3112 may communicate, like indicated by a seventh arrow 3130.

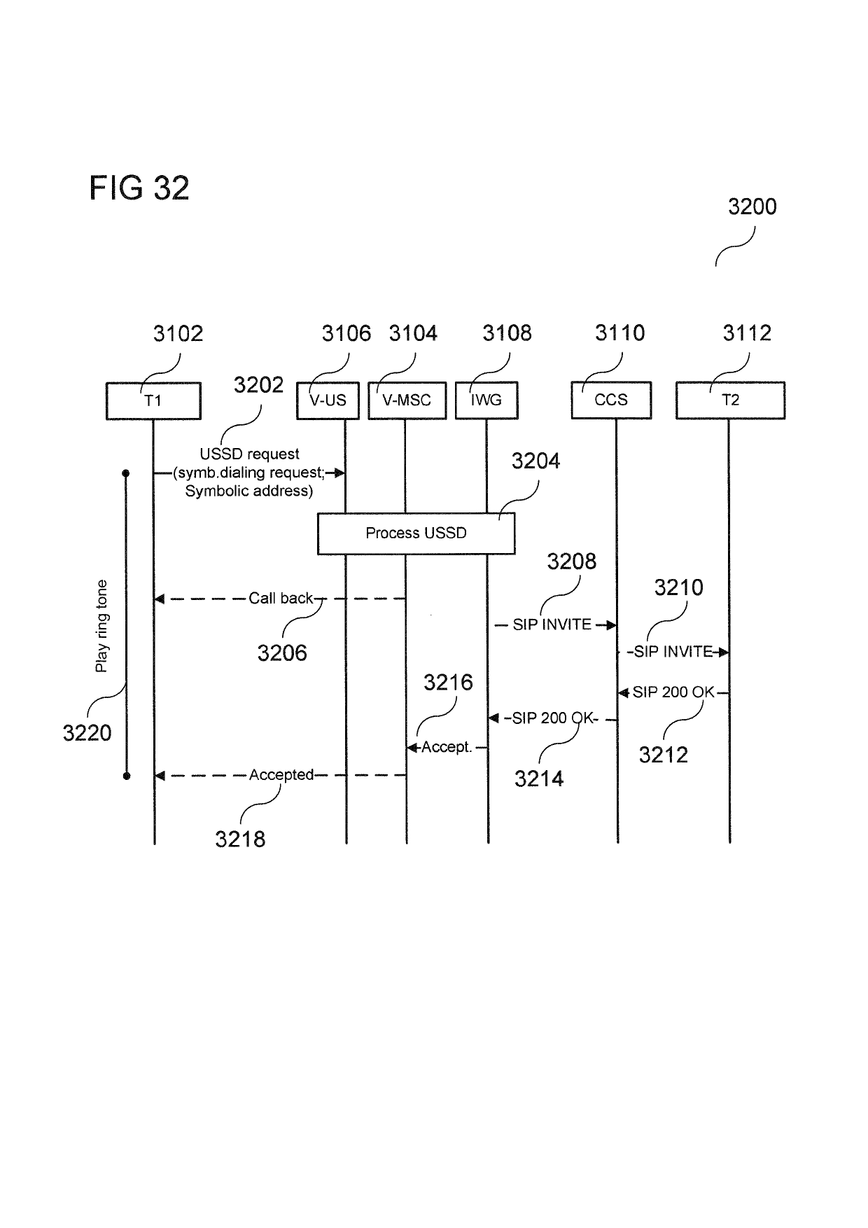

FIG. 32 shows a flow diagram 3200 illustrating a signaling flow in accordance with an aspect of this disclosure. The flow diagram 3200 may be a signaling flow for PLMN symbolic dialing of a SIP address. It may be assumed that the first user U1 has got the second user's (U2's) symbolic SIP address “xxx@operator”, for example “Harry@vodafone.com”. For example, the first user U1 may want to call user U2 using the symbolic address.

In an aspect of this disclosure, the first end device T1 3102 may send a USSD message to the visited network in 3202. The USSD message may include a USSD code indicating the symbolic address call request. The USSD message may also include the symbolic address extended by the prefix “sip:” to indicate that the symbolic address should be used to make a VoIP call.

The visited network's USSD application 3106 may find the USSD code for symbolic address calling and may determine from the prefix of the included symbolic address that a SIP end point is being addressed in 3204. The USSD application may determine from the symbolic address domain part which SIP network is targeted by the address.

Then, in 3206, the USSD application may call back the first user U1 and may, in 3208, initiate a SIP session with the target address via the SIP interworking gateway IWG 3108. In 3210, the CCS 3110 may send a SIP INVITE message to the second end device 3112.

The phone application of the first user's end device Ti (the first end device 3102) may play a ringing tone in 3220 after sending its USSD request until it receives a message from the network indicating that the called user U2 accepted the call in 3212, 3214, 3216 and 3218.

In an aspect of this disclosure, if the visited PLMN does not support symbolic dialing via USSD, then the end device may send the USSD message again to the user's home PLMN.

In an aspect of this disclosure, instead of sending the USSD message for requesting symbolic dialing first to the visited network, the USSD message may always be sent to the home network.

In an aspect of this disclosure, the USSD application of the caller's network may respond to the USSD message requesting symbolic dialing with information on the following call back for symbolic dialing. Included information may be the dialing number that will call back, the earliest time of the call back and the associated number that will be called. The responded information may allow the end device to unambiguously associate the call back with the dialing request.

In an aspect of this disclosure, symbolic addresses may be associated with dialing numbers locally in the end device after the end device received the dialing number that is associated with the dialed symbolic address. The associated dialing number stored by the device may directly be used in subsequent calls without retrieving the number by the callee's network.

In an aspect of this disclosure, if the called user can also be reached via a SIP address at his PLMN operator, then the PLMN operator may respond the user's SIP address in addition to its PLMN dialing number when the user's dialing number is requested per USSD. If the called user is not available through his PLMN dialing number then the caller's PLMN network may contact the provided SIP address via a VoIP interworking gateway. The associated SIP address may also be provided to the calling user via USSD.

In an aspect of this disclosure, symbolic addresses may also be defined for PSTN dialing numbers. In this case the PSTN may be contacted by the calling PLMN using another protocol than USSD. For example, an IP protocol may be used, for example the Hypertext Transfer Protocol (HTTP) may be used.

In an aspect of this disclosure, the prefixes “tel:” or “sip:” may be omitted if the type of address may be inferred from other information, for example from the domain indicated in the symbolic address.

In an aspect of this disclosure, multiple symbolic addresses may be defined per dialing number. For example, one address for private use and one address for business use may be defined, for example like “Harry.private@vodafone.com” and “Harry.business@vodafone.com”.

In an aspect of this disclosure, the called user may be informed before calling per USSD by his home network about which of the user's symbolic addresses will be called and at which time it will be called. This may provide that the user knows what kind of call he is receiving (for example private call or business call).

In an aspect of this disclosure, symbolic addresses may be activated and/or deactivated by the users owning the addresses. Activation and/or deactivation may be done via particular USSD messages to the user's home network.

In an aspect of this disclosure, if a symbolic address is not known at a target operator, the target operator may indicate to the caller's PLMN that the address is unknown and the caller's PLMN may indicate to the caller via USSD that the address is unknown.

In an aspect of this disclosure, if a single USSD message is too short to include a particular symbolic address, then multiple USSD messages may be concatenated in order to request symbolic dialing.

In an aspect of this disclosure, device and methods may be provided that may be used with IMS Network-Independent Public User Identities (INIPUIs). In this case the PLMN end device may include an INIPUI in its symbolic dialing request. The receiving PLMN USSD application may contact the INIPUI registry to retrieve the associated network operator dependent public user id (identifier). After having received the network operator dependent public user id the USSD application may set up a SIP session with the received public user id via a SIP interworking gateway.

In an aspect of this disclosure, if the end device's phone application does not support symbolic dialing, then symbolic dialing may still be used by the user by sending appropriate USSD strings to the visited or home PLMN.

In an aspect of this disclosure, if the target network (the called user's network) is the network the USSD message for symbolic dialing has been sent to, then the USSD application may not send a USSD message to the target network (i.e. itself) for retrieving the dialing number. Instead the dialing number may be directly retrieved by the USSD application.

In an aspect of this disclosure, a PLMN may request a dialing number associated with a given symbolic address from another network not by using USSD but using a different protocol.

In an aspect of this disclosure, communication may be provided according to at least one of the following radio access technologies: Global System for Mobile Communications (GSM) radio communication technology, a General Packet Radio Service (GPRS) radio communication technology, an Enhanced Data Rates for GSM Evolution (EDGE) radio communication technology, FOMA (Freedom of Multimedia Access), and/or a Third Generation Partnership Project (3GPP) radio communication technology (for example UMTS (Universal Mobile Telecommunications System), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System—Time-Division Duplex), TD-CDMA (Time Division—Code Division Multiple Access), TD-SCDMA (Time Division—Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), CDPD (Cellular Digital Packet Data), Mobitex, DataTAC, iDEN (Integrated Digital Enhanced Network), PDC (Personal Digital Cellular), CSD (Circuit Switched Data), PHS (Personal Handy-phone System), WiDEN (Wideband Integrated Digital Enhanced Network), iBurst, Unlicensed Mobile Access (UMA, also referred to as also referred to as 3GPP Generic Access Network, or GAN standard)), LTE TDD (LTE Time Division Duplex), TD-LTE, Worldwide Interoperability for Microwave Access (WiMax) (for example according to an IEEE 802.16 radio communication standard, for example WiMax fixed or WiMax mobile), WiPro, HiperMAN (High Performance Radio Metropolitan Area Network).

While the invention has been particularly shown and described with reference to specific aspects of this disclosure, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A network device of a network, comprising:
an interface configured to receive text from a communication end device via a communication protocol;
a memory configured to store recipient identifiers in relation to textual names; and
a recipient identifier acquirer configured to acquire from the memory a recipient identifier based on the received text;
wherein the communication protocol is configured to exchange information only between communication end devices of the network and network devices of the network.

2. The network device of claim 1, further comprising:
a recipient domain determiner configured to determine a domain to which the recipient belongs.

3. The network device of claim 1,
wherein the recipient domain determiner is further configured to determine whether the recipient belongs to a telephone domain or to an internet domain.

4. The network device of claim 3,
wherein the telephone domain is one of a domain of a public land mobile network and a domain of a public switched telephone network.

5. The network device of claim 3,
wherein the internet domain is a domain of a session initiation protocol communication.

6. The network device of claim 1, further comprising:
a connection establisher configured to establish a connection with the recipient.

7. The network device of claim 2, further comprising:
a connection establisher configured to establish a connection with the recipient;
wherein the connection establisher is further configured to establish the connection based on the determined domain.

8. The network device of claim 1,
wherein the communication protocol is a protocol for unstructured supplementary service data.

9. A communication end device, comprising:
a text sender configured to send text via a communication protocol to a network device of a network; and
a recipient identifier receiver configured to receive a recipient identifier from the network device in response to the sent text;
wherein the communication protocol is configured to exchange information only between communication end devices of the network and network devices of the network.

10. The communication end device of claim 9, further comprising:
a connection establisher configured to establish a connection with the recipient based on the received recipient information.

11. The communication end device of claim 9, further comprising:
a memory, configured to store the received recipient information.

12. The communication end device of claim 9,
wherein the communication protocol is a protocol for unstructured supplementary service data.

13. A method for controlling a network device of a network, the method comprising:
receiving text from a communication end device via a communication protocol;
storing in a memory recipient identifiers in relation to textual names; and
acquiring from the memory a recipient identifier based on the received text;
wherein the communication protocol is configured to exchange information only between communication end devices of the network and network devices of the network.

14. The method of claim 13, further comprising:
determining a domain to which the recipient belongs.

15. The method of claim 13, further comprising:
determining whether the recipient belongs to a telephone domain or to an internet domain.

16. The method of claim 15,
wherein the telephone domain is one of a domain of a public land mobile network and a domain of a public switched telephone network.

17. The method of claim 15,
wherein the internet domain is a domain of a session initiation protocol communication.

18. The method of claim 13, further comprising:
establishing a connection with the recipient.

19. The method of claim 14, further comprising:
establishing the connection based on the determined domain.

20. The method of claim 13,
wherein the communication protocol is a protocol for unstructured supplementary service data.

21. A method for controlling a communication end device, the method comprising:
sending text via a communication protocol to a network device of a network; and
receiving a recipient identifier from the network device in response to the sent text;
wherein the communication protocol is configured to exchange information only between communication end devices of the network and network devices of the network.

22. The method of claim 21, further comprising:
establishing a connection with the recipient based on the received recipient information.

23. The method of claim 21, further comprising:
storing in a memory the received recipient information.

24. The method of claim 21,
wherein the communication protocol is a protocol for unstructured supplementary service data.

25. A network device of a network, comprising:
an interface configured to receive text from a communication end device via unstructured supplementary service data;
a memory configured to store recipient identifiers in relation to textual names; and
a recipient identifier acquirer configured to acquire from the memory a recipient identifier based on the received text.
